(19) United States
(12) Patent Application Publication
(10) Pub. No.: US 2025/0374331 A1
(43) Pub. Date: Dec. 4, 2025

(54) USER EQUIPMENTS AND METHODS FOR DETERMINING TIME-FREQUENCY RESOURCE SET FOR ENHANCED DUPLEX OPERATION

(71) Applicant: SHARP KABUSHIKI KAISHA, Sakai City, Osaka (JP)

(72) Inventors: TOMOKI YOSHIMURA, Sakai City, Osaka (JP); ZHANPING YIN, Vancouver, WA (US)

(21) Appl. No.: 18/877,561

(22) PCT Filed: Jun. 27, 2023
(86) PCT No.: PCT/JP2023/023843

§ 371 Date: Dec. 20, 2024

Related U.S. Application Data
(60) Provisional application No. 63/367,465, filed on Jun. 30, 2022.

(51) Int. Cl. H04W 74/0833; H04L 5/14; H04W 74/00

(52) U.S. Cl. CPC H04W 74/0833; H04L 5/14; H04W 74/006

(57) ABSTRACT

A wireless terminal of a cellular telecommunication system comprises processor circuitry and transmitter circuitry. The processor circuitry is configured to select between a first resource allocation mode and a second resource allocation mode for determining a radio resource(s) to use for a physical uplink control channel. The transmitter circuitry is configured to transmit the physical uplink control channel using the radio resource(s) of a selected resource allocation mode.

### TECHNICAL FIELD

The technology relates to wireless communications, and particularly to wireless terminals and operations thereof including operations to avoid, reduce or mitigate interference, e.g., cross link interference.

### BACKGROUND ART

A radio access network typically resides between wireless devices, such as user equipment (UEs), mobile phones, mobile stations, or any other device having wireless termination, and a core network. Example of radio access network types includes the GRAN, GSM radio access network; the GERAN, which includes EDGE packet radio services; UTRAN, the UMTS radio access network; E-UTRAN, which includes Long-Term Evolution; and g-UTRAN, the New Radio (NR).

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprised of NG RAN, Next Generation Radio Access Network, and 5GC, 5G Core Network. As shown, NGRAN is comprised of gNBs, e.g., 5G Base stations, and ng-eNBs, i.e., LTE base stations. An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations, i.e., gNB & ng-eNB. A gNB node provides NR user plane and control plane protocol terminations towards the UE and is connected via the NG interface to the 5GC. The 5G NR, New Radio, gNB is connected to Access and Mobility Management Function, AMF, and User Plane Function, UPF, in the 5G Core Network, 5GC.

Wireless transmissions from a base station in a direction toward a wireless terminal is referred to as being on the “downlink”, DL, transmissions from the wireless terminal in a direction toward the base station is referred to as being on the “uplink”, UL. As described in more detail herein, the transmissions may occur in a frame or sub-frame structure which may be conceptualized as a two-dimensional grid. The grid may be structured to have time slots in a first dimension and frequencies or sub-carriers in a second dimension. Time division duplex, TDD, operation occurs when information of the frame or sub-frame is split on a time basis between uplink and downlink. In TDD operation there may be a mapping or assignment, referred to as a TDD pattern, of time slots to uplink and downlink transmissions. Frequency division duplex, FDD, operation occurs when information of the frame or sub-frame is split on a frequency or sub-carrier basis between uplink and downlink.

Uplink coverage is a significant factor for a radio access network. In time division duplex, TDD, operation, uplink coverage is limited by the TDD pattern since the TDD pattern determines the maximum allowable transmission power for the wireless terminal. For example, when the TDD pattern is DL heavy, e.g., when a significant number of time slots are utilized for downlink transmission, the UE has less maximum allowable transmission power. As a result, uplink coverage is limited. Conversely, if the network is deployed with a UL heavy TDD pattern, e.g., when a significant number of time slots are utilized for uplink transmission, the network cannot serve enough DL traffic. Therefore, 3GPP takes into consideration operation with simultaneous transmission/reception for base station nodes within frequency resource(s).

What is needed are methods, apparatus, and/or techniques to deal with allocation and/or selection of radio resources for uplink channels, including but not limited to situations in which Sub-Band Full Duplex, SBFD, resources are available.

### SUMMARY OF INVENTION

In one example, a wireless terminal of a cellular telecommunication system, the wireless terminal comprising: processor circuitry configured to select a PRACH resource from a first PRACH resource associated with SBFD indication and a second PRACH resource not associated with SBFD indication; transmitter circuitry configured to transmit a PUSCH scheduled by the RAR UL grant which is associated with the PRACH resource; wherein the resource of the PUSCH is determined based on whether the first PRACH resource or the second PRACH resource is selected.

In one example, a base station of a cellular telecommunication system, the base station comprising: processor circuitry configured to select a PRACH resource from a first PRACH resource associated with SBFD indication and a second PRACH resource not associated with SBFD indication; receiver circuitry configured to receive a PUSCH scheduled by the RAR UL grant which is associated with the PRACH resource; wherein the resource of the PUSCH is determined based on whether the first PRACH resource or the second PRACH resource is selected.

In one example, a method of operating a wireless terminal of a cellular telecommunication system, the method comprising: selecting a PRACH resource from a first PRACH resource associated with SBFD indication and a second PRACH resource not associated with SBFD indication; transmitting a PUSCH scheduled by the RAR UL grant which is associated with the PRACH resource; wherein the resource of the PUSCH is determined based on whether the first PRACH resource or the second PRACH resource is selected.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view of portions of a communication system in a situation in which a base station is operating with simultaneous transmission/reception within a frequency resource for a single serving cell and which illustrates self-interference at a base station and cross link interference between wireless terminals.

FIG. 3 is a diagrammatic view showing resource partition for simultaneous transmission/reception.

FIG. 4 is a diagrammatic view showing an example of frequency domain resource allocation for PUSCH with frequency hopping.

FIG. 5A is a schematic view of a communications system showing a core network, a radio access network, with the radio access network including a wireless terminal that makes a selection between a first resource allocation mode and a second resource allocation mode for determining radio resources to be utilized for an uplink channel.

FIG. 5B is a schematic view of a communications system showing a core network, a radio access network, with the radio access network including a wireless terminal which selects between differing values of frequency hop offset values for a physical uplink shared channel, PUSCH.

FIG. 5C is a schematic view of a communications system showing a core network, a radio access network, with the radio access network including a wireless terminal that aligns resources in dependence upon a selected resource allocation mode.

FIG. 5D is a schematic view of a communications system showing a core network, a radio access network, with the radio access network including a wireless terminal that selects between Sub-Band Full Duplex, SBFD, configurations.

FIG. 5E is a schematic view of a communications system showing a core network, a radio access network, with the radio access network including a wireless terminal which selects between differing values of frequency hop offset values for a physical uplink control channel, PUCCH, when one set of PUCCH is provided, or differing sets of PUCCH resources when plural sets are provided.

FIG. 5F is a schematic view of a communications system showing a core network, a radio access network, with the radio access network including a wireless terminal selects between PUCCH resources.

FIG. 6 is a flowchart view showing representative, example steps or acts performed by a wireless terminal of the communications system of the example embodiment and mode of FIG. 5A.

FIG. 7 is a flowchart showing an example procedure for a wireless terminal which implements according to an existing 3GPP standard.

FIG. 8 is a diagrammatic view showing an example procedure for a frequency resource determination as indicated by Resource Indication Value, RIV

FIG. 9 is a flowchart showing an example procedure of an enhanced wireless terminal or the example embodiment and mode of FIG. 6A.

FIG. 10 is a diagrammatic view showing an example of frequency domain resource allocation for PUSCH with frequency hopping in a case of PUSCH repetition.

FIG. 11 is a flowchart showing an example procedure of initial connection establishment procedure as specified in 3GPP TS38.300.

FIG. 12 is a diagrammatic view showing an example available slot counting.

FIG. 13 is a diagrammatic view showing an example configuration of PUCCH resources.

FIG. 14 is a flowchart showing an example procedure for PUCCH resource determination.

FIG. 15A is a diagrammatic view showing an example PUCCH resources belonging to a single set of resources in accordance with a first sub-embodiment of the example embodiment and mode of FIG. 5E.

FIG. 15B is a diagrammatic view showing an example PUCCH resources belonging to two sets of resources in accordance with a second sub-embodiment of the example embodiment and mode of FIG. 5E.

FIG. 16 is a flowchart showing example acts included in a random access procedure.

FIG. 17 is a diagrammatic view showing example elements comprising electronic machinery which may comprise a wireless terminal, a radio access node, and a core network node according to an example embodiment and mode.

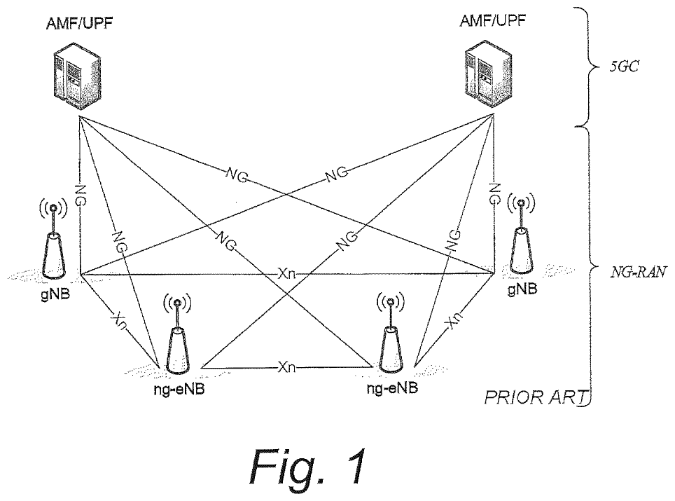

### DESCRIPTION OF EMBODIMENTS

In some of its example aspects the technology disclosed herein concerns a wireless terminal of a cellular telecommunication system. The wireless terminal comprises processor circuitry and transmitter circuitry. The processor circuitry is configured to select between a first resource allocation mode and a second resource allocation mode for determining a radio resource(s) to use for an uplink channel. The transmitter circuitry is configured to transmit the uplink channel using the radio resource(s) of a selected resource allocation mode. Methods of operating such wireless terminals are also provided.

In others of its example aspects the technology disclosed herein concerns an access node of a cellular communication system that communications over an air or radio interface with a wireless terminal. The access node comprises receiver circuitry configured to receive the uplink channel using the radio resource(s) of the selected resource allocation mode. Methods of operating such base stations are also provided.

In others of its example aspects the technology disclosed herein concerns a cellular telecommunication system comprising an access node and a wireless terminal. The access node comprises access node processor circuitry, access node transmitter circuitry, and access node receiver circuitry. The access node processor circuitry is configured to store sub-band full duplex (SBFD) configuration information. The access node transmitter circuitry is configured to transmit the sub-band full duplex (SBFD) configuration information over a radio interface. The wireless terminal comprises wireless terminal receiver circuitry and wireless terminal processor circuitry. The wireless terminal receiver circuitry is configured to receive the sub-band full duplex (SBFD) configuration information over the radio interface. The wireless terminal processor circuitry is configured use the sub-band full duplex (SBFD) configuration information to select between a first resource allocation mode and a second resource allocation mode for determining a radio resource(s) to use for an uplink channel. The wireless terminal transmitter circuitry is configured to transmit the uplink channel using the radio resource(s) of a selected resource allocation mode. The access node receiver circuitry is configured to receive over the radio interface the uplink channel using the radio resource(s) of a selected resource allocation mode. Access nodes of such systems, methods of operating such access nodes, and methods of operating such systems are also provided.

In some of the example embodiment and modes the uplink channel is a physical uplink shared channel, PUSCH, while in others of the example embodiments and modes the uplink channel is a physical uplink control channel, PUCCH. Therefore, differing example embodiments and modes of wireless terminals, access nodes, and systems are provided in accordance with uplink channel type, although the various example embodiments and modes may be used in combination for both PUSCH and PUCCH.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel. All or a subset of the cell may be adopted by 3GPP as licensed bands, e.g., frequency band, to be used for communication between a base station, such as a Node B, and a UE terminal. A cellular network using frequency bands can include configured cells. Configured cells can include cells of which a UE terminal is aware and in which it is allowed by a base station to transmit or receive information. Examples of cellular radio access networks include E-UTRAN or New Radio, NR, and any successors thereof, e.g., NUTRAN.

A core network, CN, such as core network (CN) 22 may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. For example, core network (CN) 22 may comprise one or more management entities, which may be an Access and Mobility Management Function, AMF.

As used herein, for a UE in IDLE Mode, a “serving cell” is a cell on which the wireless terminal in idle mode is camped. See, e.g., 3GPP TS 38.304. For a UE in RRC_CONNECTED not configured with carrier aggregation, CA/dual connectivity, DC, there is only one serving cell comprising the primary cell. For a UE in RRC_CONNECTED configured with CA/DC the term ‘serving cells’ is used to denote the set of cells comprising of the Special Cell(s) and all secondary cells. See, e.g., 3GPP TS 38.331.

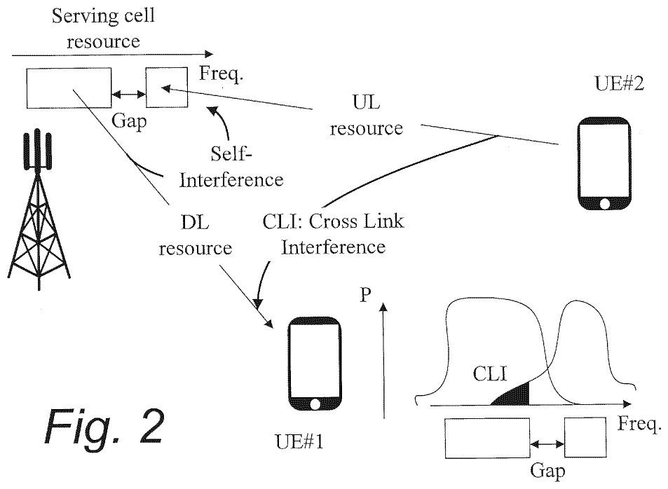

FIG. 2 shows a situation in which a base station is operating with simultaneous transmission/reception within frequency resource for a single serving cell. In the situation shown in FIG. 2, handling of two additional interference types needs to be considered. One type of interference is self-interference at the gNB-side. Another type of interference is UE-to-UE inter-subband CLI (Cross Link Interference) at UE-side, illustrated in FIG. 2 between UE#1 and UE#2. As used herein, “subband” denotes a set of continuous resources in/with one direction. For example, the DL resource shown in FIG. 2 may be in a DL subband, and UL resource shown in FIG. 2 may be in a UL subband.

As shown by way of example in FIG. 2, the self-interference denotes interference from the DL transmission in the DL resource to the UL reception in the UL resource at gNB-side. The interference comes from channel leakage of DL transmission. Channel leakage occurs due to RF non-linearity, e.g., a power amplifier has non-linearity in general.

As shown by way of example in FIG. 2, the UE-to-UE inter-subband cross link interference, CLI, denotes interference from UL transmission at one UE, e.g., UE#2, to DL reception at another UE, e.g., UE#1. The interference also comes from channel leakage of the UL transmission.

As an example of possible cross link interference mitigation operation for the situation of FIG. 2, the UE#2 may filter out transmission power outside a subset of UL frequency resource which may or may not be different from an actual physical uplink shared channel, PUSCH, frequency resource. There are two possible ways or modes for filtering out transmission power. A first mode comprises UE#1 filtering out transmission power outside the PUSCH. A second mode comprises UE#2 filtering out transmission power outside the subset of UL frequency resource.

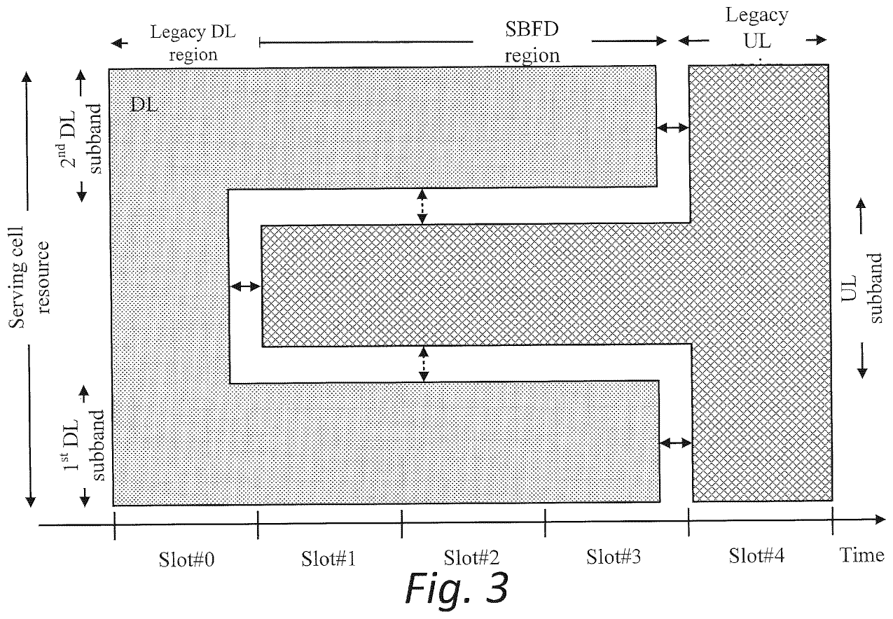

FIG. 3 shows an example of serving cell resource partitioning, such that which has been agreed as a Sub-Band Full Duplex, SBFD, configuration at RAN1#109 e-meeting. See, for example, RP-213591, New SI: Study on evolution of NR duplex operation. As used herein, “subband” means a set of continuous resource blocks, RBs, in the frequency domain. FIG. 3 corresponds to SBFD Subband configuration #1 with Alternative 1 for deployment case 1. On the other hand, the invention is not limited to a subband comprised of a set of continuous resource blocks. For example, it is possible to define one subband comprised of a set of resource blocks corresponding to the 1^{st} DL subband and a set of resource blocks corresponding to the 2^{nd} DL subband.

RAN documents pertaining to various RAN “agreements include statements such as those which are selectively reproduced in Table 1.

TABLE 1
SELECTED RAN AGREEMENTS

For SBFD evaluation, consider the following for SBFD subband
configurations:
SBFD Subband configuration#1 with {DUD} pattern, wruch means
one SBfD slot consists of one UL subband at the center of
the channel bandwidth and two DL subbands at two sides of
the channel bandwidth.
SBFD Subband configuration#2 with {DU} pattern, which means
one SBFD slot consists of one UL subband at one side of the
channel bandwidth and one DL subband at the other side of
the channel bandwidth.
Use the following parameters for description of SBFD subband
configuration in evaluation assumptions:
N_{D}: the number of RBs in one DL subband
N_{U}: the number of RBs in one UL subband
N_{G}: the number of RBs in one guard band between one UL
subband and one DL subband.
For performance evaluation and comparison between baseline legacy
TDD operation and SBFD operation wider SBFD Deployment Case I
(Non-coexistence case with single SBFD subband configuration),
consider the following alternatives:
Alt 2 (No SBFD DL subband in the slots/symbols that
correspond to UL slots/symbols in legacy TDD):
Legacy TDD: Static TDD UL/DL configuration with {DDDSU},
where S = [12D:2G:OU]
SBFD: Frame structure#2 (XXXXU), where X denotes a SBFD
slot. In time domain, SBFD UL subband spans all the
symbols in a SBFD slot. In frequency domain, SBFD UL
subband is about [20%] of the channel bandwidth.
Alt 4 (strive for the same UL/DL resource ratio between
Legacy TDD and SBFD):
Legacy TDD: Static TDD UL1DL configuration with {DDDSU},
where S = [12D:2G:OU]
SBFD: Frame structure#3 (XXXXX), where X denotes a SBFD
slot. In time domain, SBFD UL subband spans all the
symbols in a SBFD slot. In frequency domain, SBFD UL
subband is about[20%] of the channel bandwidth.
Alt 1 (No SBFD DL subband in the slots/symbols that
correspond to UL slots/symbols in legacy TDD):
Legacy TDD: Static TDD UL/DL configuration with {DDDSU},
where S = [12D:2G:OU]
SBFD: Frame structure#1 (DXXXU), where X denotes a SBFD
slot. In time domain, SBFD UL subband spans all the
symbols in a SBFD slot. In frequency domain, SBFD UL
subband is about [20%] of the channel bandwidth.
Alt 3 (strive for the same UL/DL resource ratio between
Legacy TDD and SBFD):
Legacy TDD: Static TDD UL/DL configuration with {DDSUU},
where S = [12D:2G:OU]
SBFD: Frame structure#2 (XXXXU), where X denotes a SBFD
slot. In time domain, SBFD UL subband spans all the
symbols in a SBFD slot. In frequency domain, SBFD UL
subband is about [20%] of the channel bandwidth.
FFS: whether dynamic TDD can optionally be used for legacy
TDD for comparison.

In FIG. 3, the vertical domain represents the frequency domain resource and the horizontal domain represents the time domain resource. FIG. 3 shows the DL resources by stippling and shows the uplink resources by cross hatching. In the frequency domain, a serving cell frequency resource is divided into two DL subbands and one UL subband. Note that one subband may or may not include a gap. The gap is represented by a dotted line. In the time domain, a time duration of 5 slots is further divided, as shown from left to right in FIG. 3, into the legacy DL region, the SBFD region, and the legacy DL region.

As described herein, a serving cell-wise TDD pattern is denoted as DXXXU, where X represents SBFD slots. The SBFD slots are slots within the SBFD region. On the other hand, subband-wise TDD patterns are DDDDU for the DL subbands, and DUUUU for the UL subband. FIG. 3 assumes that an information element or parameter tdd-UL-DL-configurationCommon in the system information, e.g., system information broadcast to the network, provides DDDDU as a common TDD pattern, which is different from the serving cell-wise TDD pattern.

As a first example, the SBFD region may be a region where a first TDD pattern indicates DL and a second TDD pattern indicates UL in the same symbol. For example, the first TDD pattern may be a pattern indicated by tddUL-DL-configurationCommon and the second TDD pattern may be a pattern indicated by information which is different from tdd-UL-DL-configurationCommon. For example, the information may be provided via tdd-UL-DL-configurationDedicated.

As a second example, the SBFD region may be a region where a first TDD pattern indicates flexible and a second TDD pattern indicates UL in the same symbol. For example, the first TDD pattern may be a pattern indicated by tdd-UL-DL-configurationCommon and the second TDD pattern may be a pattern indicated by information which is different from tdd-UL-DL-configurationCommon. For example, the information may be provided via tdd-UL-DL-configurationDedicated.

As a third example, the SBFD region may be a region where a first TDD pattern indicates UL and a second TDD pattern indicates DL in the same symbol. For example, the first TDD pattern may be a pattern indicated by tddUL-DL-configurationCommon and the second TDD pattern may be a pattern indicated by information which is different from tdd-UL-DL-configurationCommon. For example, the information may be provided via tdd-UL-DL-configurationDedicated.

As a fourth example, the SBFD region may be a region where a first TDD pattern indicates flexible and a second TDD pattern indicates DL in the same symbol. For example, the first TDD pattern may be a pattern indicated by tddUL-DL-configurationCommon and the second TDD pattern may be a pattern indicated by information which is different from tdd-UL-DL-configurationCommon. For example, the information may be provided via tdd-UL-DL-configurationDedicated.

As a fifth example, the SBFD region may be a region where a first TDD pattern indicates DL and a second TDD pattern associated with a UL subband indicates UL in the same symbol. For example, the first TDD pattern may be a pattern indicated by tdd-UL-DL-configurationCommon and the second TDD pattern may be a pattern indicated by information which is different from tdd-UL-DL-configurationCommon. For example, the information may be provided information dedicated for the UL subband.

As a sixth example, the SBFD region may be a region where a first TDD pattern indicates flexible and a second TDD pattern associated with a UL subband indicates UL in the same symbol. For example, the first TDD pattern may be a pattern indicated by tdd-UL-DL-configurationCommon and the second TDD pattern may be a pattern indicated by information which is different from tdd-UL-DL-configurationCommon. For example, the information may be provided information dedicated for the UL subband.

As a seventh example, the SBFD region may be a region where a first TDD pattern indicates UL and a second TDD pattern associated with DL subband indicates DL in the same symbol. For example, the first TDD pattern may be a pattern indicated by tdd-UL-DL-configurationCommon and the second TDD pattern may be a pattern indicated by information which is different from tdd-UL-DL-configurationCommon. For example, the information may be provided information dedicated for the DL subband.

As an eighth example, the SBFD region may be a region where a first TDD pattern indicates flexible and a second TDD pattern associated with DL subband indicates DL in the same symbol. For example, the first TDD pattern may be a pattern indicated by tdd-UL-DL-configurationCommon and the second TDD pattern may be a pattern indicated by information which is different from tdd-UL-DL-configurationCommon. For example, the information may be provided information dedicated for the DL subband.

In one of more of the foregoing, the second TDD pattern may be provided per subband.

It was agreed at a RAN1#109 e-meeting that 3GPP RAN1 will study potential enhancements of resource allocation in SBFD region. See, e.g., for example, RP-213591, New SI: Study on evolution of NR duplex operation.

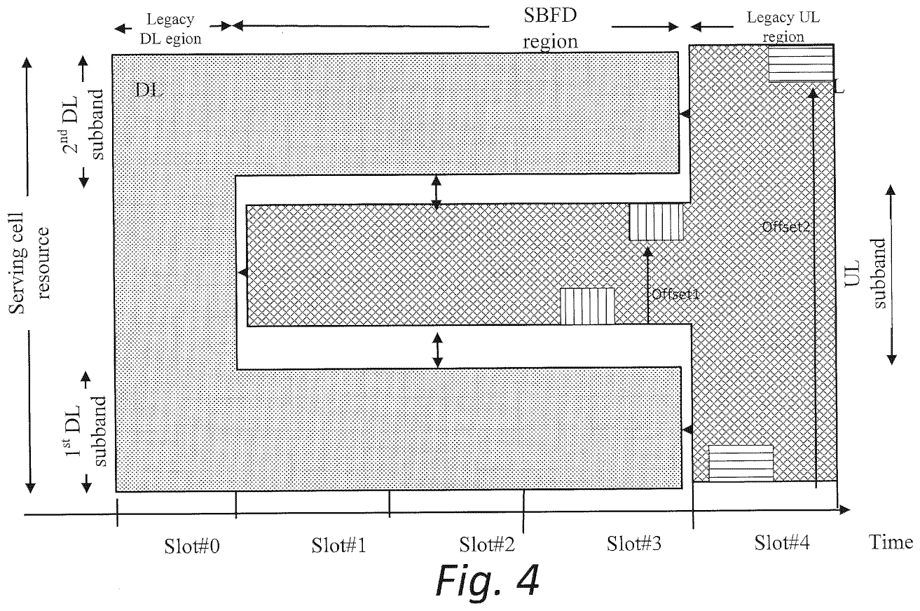

FIG. 4 is an example of frequency domain resource allocation for PUSCH with frequency hopping. In the discussion of FIG. 4 it is assumed that an uplink bandwidth part, UL BWP, has the same size and location as the serving cell resource. The technology disclosed herein is not restricted in terms of area, but is also applicable to cases where BWP size and/or location is different from the serving cell resource.

In FIG. 4, two examples are shown where one resource, shown by vertically hatching, is allocated for PUSCH in the SBFD region and another resource, shown by horizontal hatching, is allocated for PUSCH in the legacy UL region. The frequency domain resource allocation of first PUSCH in the SBFD region is confined within UL subband. The frequency domain resource allocation of first PUSCH in the SBFD region is spread over the serving cell frequency resource, to maximize frequency diversity gain. To achieve different frequency hopping pattern, the base station should provide two offset values (i.e., offset1 and offset2) to a wireless terminal, e.g., to the UE. As depicted in FIG. 4, the first offset value is “offset1” and the second offset value is “offset2”. There are several methods to indicate the wireless terminal an appropriate offset to choose among the two possibilities of offset1 and offset2.
Method 1: The base station indicates one offset among two by using indication in a DCI which schedules a PUSCH where the two offsets are provided to the UE by RRC signaling.
Method 2: The base station provides two offsets by RRC signaling and the UE selects one among the two based on whether the PUSCH is in the SBFD region or not.
   With method 1, 1 bit indication is required in each respective DCIs. For non-fallback DCI format like DCI format 0_1 or 0_2, adding 1 bit in the DCI format is an easy task. However, for fallback DCI format like DCI format 0_0, adding 1 bit is not easy. Therefore, one possible solution is to add 1 bit indication only in DCI format 0_1 and 0_2. The solution implies that dynamic switching of offsets by DCI is not supported in the fallback DCI format.

On the other hand, method 2 supports dynamic switching of offsets for all the DCI formats including the fallback DCI format. Example detailed steps for the above-described method 2 are shown in Table 2.

TABLE 2
UE DETERMINING FROM AMONG TWO OFFSETS
PROVIDED BY RRC SIGNALING

Step 1: The base station provides two offsets to the UE via RRC
signaling.
Step 2: The UE stores the two offsets.
Step 3: The base station schedules a PUSCH by using a DCI format.
Step 4: The UE which detected the DCI format determines whether
the PUSCH is in the SFBD region or not.
Step 5: The UE determines one offset among the two offsets.
For example, the UE determines first offset to be applied to the
PUSCH in a case that the PUSCH is in the SBFD region and determines
second offset to be applied to the PUSCH in a case that the PUSCH
is in the legacy UL region.

While Sub-Band Full Duplex, SBFD, technology is advantageous, problems or issues can arise particularly for uplink channel resource allocations. Various example problems or issues are introduced briefly below, and then addressed in the example embodiments and modes described herein.

For PUSCH scheduled by random access response grant, offset values are predefined in the existing 3GPP standard. Candidate values are

$$⌊ {N}_{BWP}^{size} / 2 ⌋ , ⌊ {N}_{BWP}^{size} / 4 ⌋ , and - ⌊ {N}_{BWP}^{size} / 2 ⌋$$

where

$${N}_{BWP}^{size}$$

is the number of resource blocks m the initial UL bandwidth part. When

$${N}_{BWP}^{size} = 273$$

(assuming 100 MHz with 30 kHz SCS) and the number of resource blocks in UL subband

$${N}_{BWP}^{size} = 51$$

are assumed, the offsets

$$⌊ {N}_{BWP}^{size} / 2 ⌋ = 136 , ⌊ {N}_{BWP}^{size} / 4 ⌋ = 68 , and - ⌊ \frac{{N}_{BWP}^{size}}{2} ⌋ = - 136$$

exceeds

$${N}_{subband}^{size} = 51.$$

This implies that the second hop for the PUSCH goes outside of the UL subband in any case. Thus, there is a first problem or first issue: frequency hopping for a PUSCH, e.g., as scheduled by random access response grant, does not work properly in the SBFD region.

Repetition of an uplink channel, such as PUSCH repetition in multiple slots of a frame, may be advantageous for various regions. For example, PUSCH repetition is useful to enhance the communication coverage because overall transmission power for one PUSCH doubles when the UE performs transmission in two slots (i.e., two repetitions). However, PUSCH repetition may cause a second problem, i.e., a second issue. For example, if the frequency resource is different for each PUSCH repetition. The wireless terminal is required to perform different signal generation procedure, e.g., precoding, resource mapping, OFDM signal generation, etc., which may consume more terminal processing resources and complicate operation.

A third issue or problem may be that the base station cannot control the frequency domain resource allocation for the wireless terminal before RRCReconfiguration because the wireless terminal does not know the size and location of UL subband.

A fourth issue or problem is that an appropriate frequency hopping resource determination is required also for the physical uplink control channel, PUCCH.

A fifth issue or problem addressed herein is that the frequency resource for PUCCH conveying msg4 HARQ-ACK information cannot be confined within the UL subband.

The technology disclosed herein concerns various example embodiments and modes a wireless terminal(s) and method(s) of operation thereof which addresses one or more of the problems or issues described above.

### A: Selecting Between Resource Utilization Modes

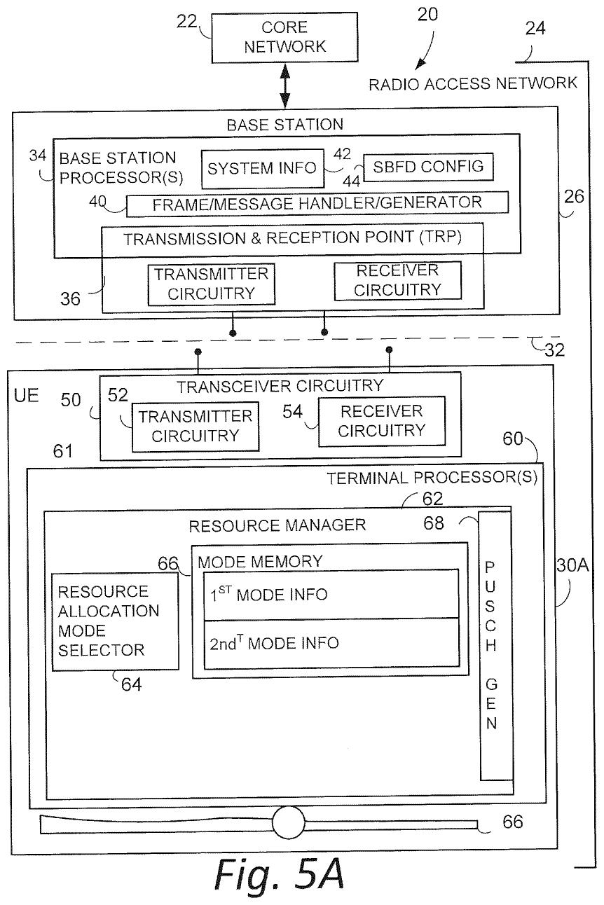

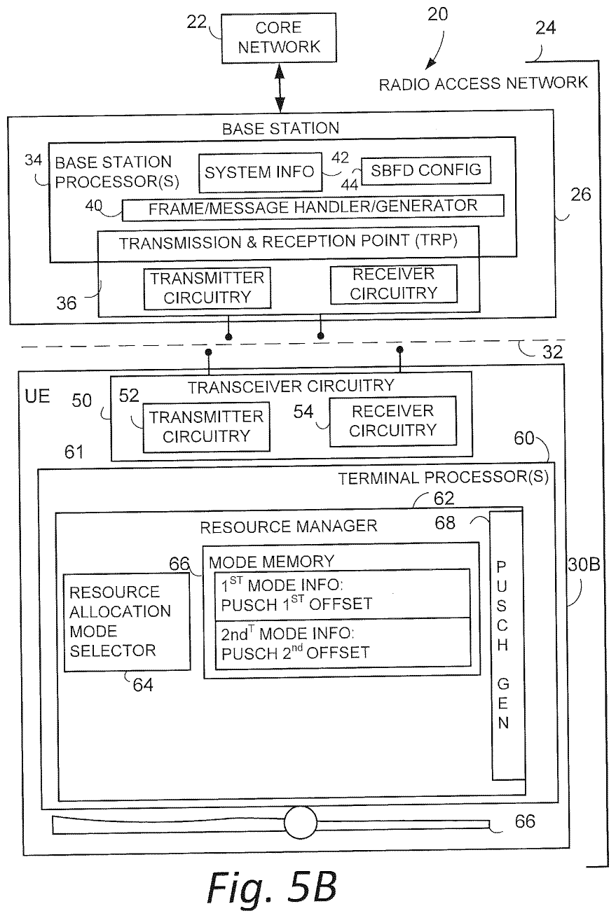

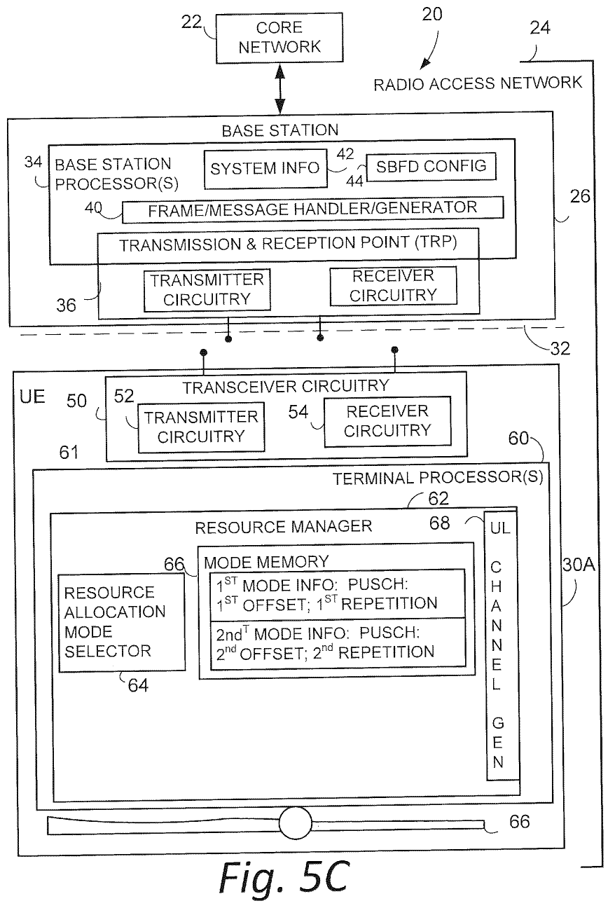

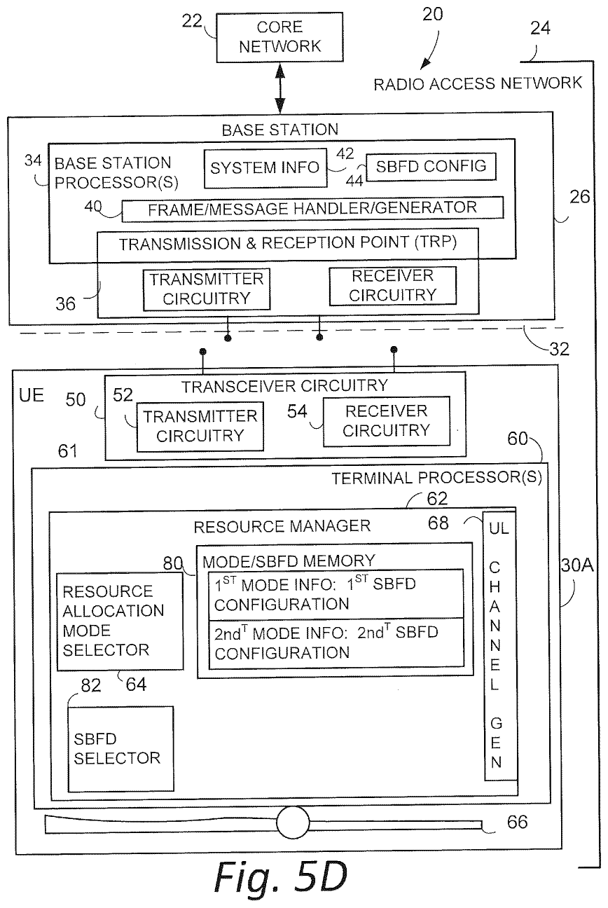

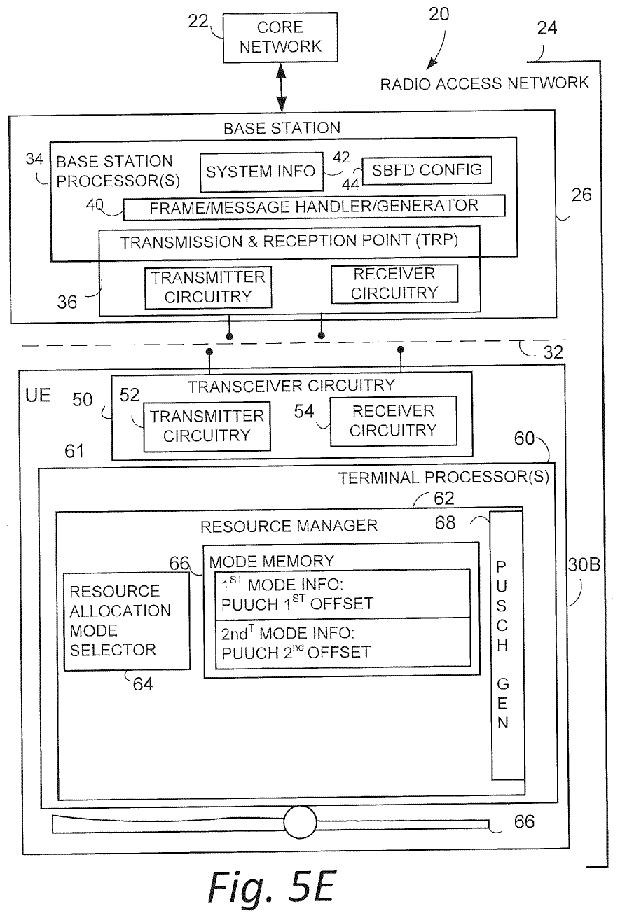

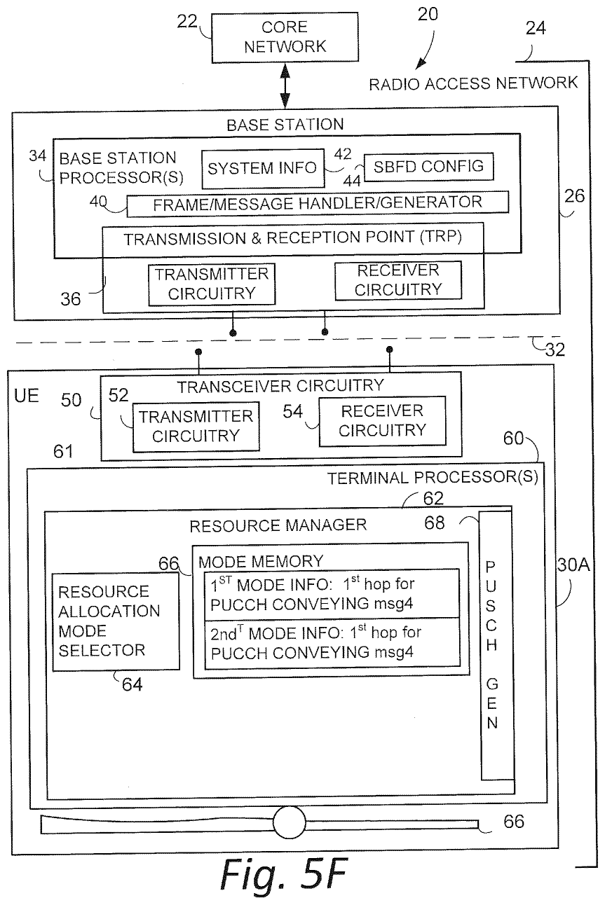

FIG. 5A shows a communications network including a wireless terminal which selects between a first resource allocation mode and a second resource allocation mode for determining a radio resource(s) to use for an uplink channel, and which transmits the uplink channel using the radio resource(s) of a selected resource allocation mode. The example embodiment and mode of FIG. 5A is generic to other example embodiments and modes described herein, including the example embodiments and modes of FIG. 5B, FIG. 5C, FIG. 5D, FIG. 5E, and FIG. 5F. For the example embodiments and modes of FIG. 5B-FIG. 5D, the uplink channel is a physical uplink shared channel, PUSCH. For the example embodiments and modes of FIG. 5E-FIG. 5F, the uplink channel is a physical uplink control channel, PUCCH. The example embodiments and modes of FIG. 5B-FIG. 5F address, e.g., the respective five issues or problems described above. The features and aspects of the example embodiments and modes of FIG. 5B-FIG. 5F may be utilized individually, or in combination.

The phrase “resource allocation mode”, as in “first resource allocation mode” and “second resource allocation mode”, may be used interchangeably with the phrases “frequency resource determination mode” and “resource utilization mode” since all phrases are intended to have substantially the same meaning.

FIG. 5A shows a system diagram of an example communications network 20 which selects between a first resource allocation mode and a second resource allocation mode for determining a radio resource(s) to use for an uplink channel. The network 20, which may be a 5G network, for example, comprises core network 22 connected to at least one radio access network 24. The radio access network 24 in turn comprises one or more radio access network (RAN) nodes, such as example base station node 26 which is shown as being connected to the core network 22 by wireline(s) 28. The base station node 26 serves at least one cell.

The radio access network, RAN, 24 typically comprises plural access nodes, one example access nodes 26 being illustrated as a base station node in FIG. 5A. As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), a relay node, a mobile relay node, or some other similar terminology.

FIG. 5A shows the radio access network 24, and base station node 26 through its cell in particular communicating with wireless terminal 30A across a radio or air interface 32. The base station node 26 may, and usually does, communicate with plural wireless terminals across the air interface 32. Only one wireless terminal 30A is shown for sake of simplicity, it being understood that other wireless terminals may be provided and may operate in similar manner as the wireless terminal 30A herein illustrated.

FIG. 5A shows base station node 26 as comprising base station processor circuitry which may comprise one or more base station processors 34, as well as base station transceiver circuitry 36. As illustrated in FIG. 5A, the base station transceiver circuitry 36 may be a transmission and reception point (TRP). The transmission and reception point (TRP) 36 may further comprise transmitter circuitry and receiver circuitry. The base station processors 34 may comprise frame/message handler/generator 40 which prepares and generates information including user data and messages, e.g., signaling, for transmission over the radio interface 32, as which also processes information received over the radio interface 32. The base station processors 34 may also comprise system information block, SIB, generator 42 which serves to generate or at least store system information which is broadcast over the radio interface 32. The base station processors 34 may also comprise SBFD configuration memory 44, which stores the configuration of the Sub-Band Full Duplex, SBFD, region. In some example embodiments and modes or scenarios, the SBFD configuration information may be included in the system information generated by system information block, SIB, generator 42. In other example embodiments and modes or scenarios, the SBFD configuration information may be included in radio resource control, RRC, signaling generated by a radio resource control unit which comprises base station processors 34 and which is included in a RRC message generated by frame/message handler/generator 40.

As used herein, SBFD configuration is comprised of information for configuring the wireless terminal. For SBFD configuration may include information for configuring some or all of UL subband, DL subband, and SBFD region. For example, SBFD configuration may include information indicating SBFD region. For example, SBFD configuration may include information indicating TDD pattern. For example, SBFD configuration may include information indicating size and/or location of UL subbands. For example, SBFD configuration may include information indicating size and/or location of DL subbands.

The base station node 26 may be structured essentially as shown in FIG. 5A or may be a node having architecture such as split architecture comprising a central unit and one or more distributed units that comprise mobile termination (MT). The base station processor(s) may include one or more TRPs.

Communication between radio access network (RAN) 22 and wireless terminal over the radio interface 32 may occur on various layers. Layer 1 includes radio layer 1 or the physical layer. Higher layers, e.g., layers higher than Layer 1 may include radio layer 2 and radio resource control layer 3. The layer 1 communication may occur by utilization of “resources”. Reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource may occur in the context of a “frame” of information that is typically formatted and prepared, e.g., by a node. A frame, which may have both downlink portion(s) and uplink portion(s), is communicated between the base station and the wireless terminal. Each frame may comprise plural subframes. For example, in the time domain, a 10-millisecond frame consists of ten one millisecond subframes. A subframe is divided into one or more slots (so that there are thus a multiple of 10 slots in a frame). The transmitted signal in each slot is described by a resource grid comprised of resource elements (RE). Each column of the two-dimensional grid represents a symbol (e.g., an OFDM symbol) from node to wireless terminal. Each row of the grid represents a subcarrier. A resource element, RE, is the smallest time-frequency unit for transmission in the subframe. That is, one symbol on one sub-carrier in the sub-frame comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The frequency resource supported by the standard today is a set of plural subcarriers in one OFDM symbols (e.g., plural resource elements (RE)) and is called a resource block (RB). A resource block may comprise, for example, 12 resource elements, i.e., 12 subcarriers and 7 symbols.

In 5G New Radio (“NR”), a frame consists of 10 millisecond, milli-second, duration. A frame consists of 10 subframes with each having 1 ms duration like LTE. Each subframe consists of 2^{μ} slots. Each slot can have either 14 (normal CP) or 12 (extended CP) OFDM symbols. A Slot is typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. A mini-slot helps to achieve lower latency in 5G NR architecture. Unlike slot, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

As used herein, “serving cell frequency resource” refers to a plurality of radio resources which may radio resources comprising layer 1 communications between base station node 26 and wireless terminal 30. As such, “serving cell frequency resource” encompasses and includes a frame, having examples described above, or a resource grid, or plural carriers, for example. The serving cell frequency resource typically includes a control region. In New Radio, the control region can be placed in any region in time/frequency domain, whereas in some earlier LTE versions the control region should be preferably located in the beginning of a subframe. The control region may include scheduling information. An example of scheduling information is a PDCCH with a downlink control indication, DCI, format. The scheduling information may describe or reference other portions of the serving cell frequency resource. The other portion of serving cell frequency resource that may be described or referenced by the scheduling information may be one or more physical channels. An example of scheduling information 46 is a PDCCH with a DCI format. An example physical channel is a physical downlink shared channel, PDSCH.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

FIG. 5A also shows various example constituent components and functionalities of wireless terminal 30A. For example, FIG. 5A shows wireless terminal 30A as comprising terminal transceiver circuitry 50. The transceiver circuitry 50 in turn may comprise terminal transmitter circuitry 52 and terminal receiver circuitry 54. The terminal transceiver circuitry 50 may include antenna (e) for the wireless transmission. Terminal transmitter circuitry 52 may include, e.g., amplifier(s), modulation circuitry and other conventional transmission equipment. Terminal receiver circuitry 54 may comprise, e.g., amplifiers, demodulation circuitry, and other conventional receiver equipment.

FIG. 5A further shows wireless terminal 30A also comprising wireless terminal processor circuitry, e.g., one or more wireless terminal processor(s) 60. The wireless terminal 30A, e.g., wireless terminal processor(s) 60, may comprise resource manager 62. The resource manager 62 may also be referred to or function as a frame/message generator/handler. In an example embodiment and mode, the serving cell frequency resource manager 62 is further shown as comprising example functionalities including resource allocation mode selector 64, resource mode memory 66; and uplink channel generator 68. In the generic FIG. 5A example embodiment and mode, the resource mode memory 66 stores information for the first resource allocation mode and information for the second resource allocation mode. The information for the first resource allocation mode as stored in resource mode memory 66 may comprise at least one of a first offset indication and a first repetition indication, and the information for the second resource allocation mode as stored in resource mode memory 66 may comprise at least one of a second offset indication and a second repetition indication. Preferably at least one the first offset indication and the first repetition indication of the first resource allocation mode differs from the respective second offset indication and the second repetition indication of the second resource allocation mode.

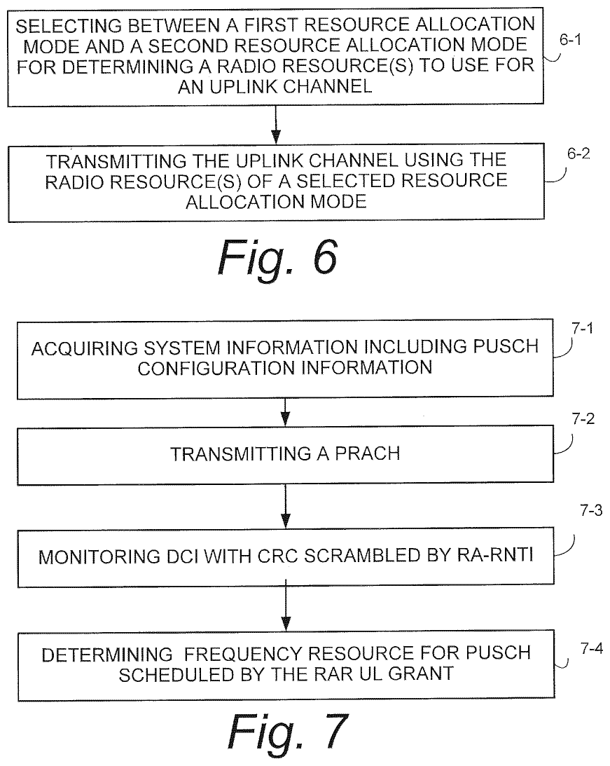

FIG. 6 shows example acts or steps performed by the wireless terminal 30A of FIG. 5A. Act 6-1 comprises the wireless terminal, e.g., resource allocation mode selector 64 making a selection between the first resource allocation mode and the second resource allocation mode for determining a radio resource(s) to use for an uplink channel. Upon making the section and obtaining the information for the selected mode from resource mode memory 66, the uplink channel generator 68 generates the uplink channel. Act 6-2 comprises transmitting the uplink channel as generated by uplink channel generator 68 over the radio interface 32. The uplink channel may be transmitted by wireless terminal transmitter circuitry 53. The uplink channel may be either a physical uplink shared channel, PUSCH, or a physical uplink control channel, PUCCH.

As described herein, the resource allocation mode selector 64 may make a selection between the first resource allocation mode and the second resource allocation mode in dependence upon one or more factors or events. For example, the resource allocation mode selector 64 may make either selection between the first resource allocation mode and the second resource allocation mode in dependence upon one or more of the following: (1) whether an initial resource of the uplink channel overlaps with a first region of radio sources or a second region of radio resources; and (2) a parameter of a random access procedure. As a first example of a determination dependent on resource overlap, the resource allocation mode selector 64 may select between the first resource allocation mode and the second resource allocation mode for determining the radio resource(s) to use for the uplink channel in dependence upon whether a frequency resource of the uplink channel overlaps with the first region of radio sources or the second region of radio resources. As a second example of a determination dependent on resource overlap, the resource allocation mode selector 64 may select between the first resource allocation mode and the second resource allocation mode for determining the radio resource(s) to use for the uplink channel in dependence upon a first hop for the uplink channel overlaps with a DL subband or an UL subband.

In an example embodiment and mode the resource allocation mode selector 64 selects a first resource allocation mode when the initial resource of the uplink channel overlaps with a legacy uplink resource region. The legacy uplink resource region is a region that does not include a sub-band full duplex (SBFD) region and may be described by example by an information element tdd-UL-DL-configurationCommon. In an example embodiment and mode the resource allocation mode selector 64 selects the second resource allocation mode when the initial resource of the uplink channel overlaps with a sub-band full duplex (SBFD) region.

As a first example of a determination dependent on random access procedure, the mode selector 64 may select between the first resource allocation mode and the second resource allocation mode for determining the radio resource(s) to use for the uplink channel in dependence upon information included in a random access response, RAR, grant. As a second example of a determination dependent on random access procedure, the mode selector 64 may select between the first resource allocation mode and the second resource allocation mode for determining the radio resource(s) to use for the uplink channel in dependence upon a downlink control information received by the wireless terminal.

The wireless terminal 30A may also comprise user interfaces 66, including one or more user interfaces. Such user interfaces may serve for both user input and output operations, and may comprise (for example) a keyboard, a mouse, a screen such as a touch screen that can both display information to the user and receive information entered by the user. The user interface 66 may also include other types of devices, such as a speaker, a microphone, or a haptic feedback device, for example.

### B: Frequency Hopping for PUSCH with SBFD

The communications system 20 of the example embodiment and mode of FIG. 5B addresses, e.g., the first issue or problem described above, i.e., that frequency hopping for a PUSCH scheduled by random access response grant may not work properly in the SBFD region. The structures, functionalities, and operations of the example embodiment and mode of FIG. 5B are essentially the same as those shown by corresponding reference numerals in the preceding figures, unless otherwise noted or evident from the context. In addition, FIG. 5B shows the resource mode memory 66 as storing different frequency hopping offset values for the first resource allocation mode and the second resource allocation mode. As described above, the candidate frequency hopping offset values for the first resource allocation mode may be

$$⌊ {N}_{BWP}^{size} / 2 ⌋ , ⌊ {N}_{BWP}^{size} / 4 ⌋ , and - ⌊ {N}_{BWP}^{size} / 2 ⌋$$

where

$${N}_{BWP}^{size}$$

is the number of resource blocks in the initial UL bandwidth part. When

$${N}_{BWP}^{size} = 273$$

(assuming 100 MHz with 30 kHz SCS) and the number of resource blocks in UL subband

$${N}_{subband}^{size} = 51.$$

are assumed, the offsets are

$$⌊ {N}_{BWP}^{size} / 2 ⌋ = 136 , ⌊ {N}_{BWP}^{size} / 4 ⌋ = 68 , and - ⌊ \frac{{N}_{BWP}^{size}}{2} ⌋ = - 136.$$

The example embodiment and mode of FIG. 5B solves issue #1 by adopting, for the second resource allocation mode, different offset values than

$$⌊ {N}_{BWP}^{size} / 2 ⌋ , ⌊ {N}_{BWP}^{size} / 4 ⌋ , and - ⌊ {N}_{BWP}^{size} / 2 ⌋ .$$

For example, for the second resource allocation mode the offset values may be based on the UL subband size

$${N}_{subband}^{size} .$$

For example, for the second resource allocation mode the candidate offset values may be some or all of

$$⌊ {N}_{subband}^{size} / 2 ⌋ , ⌊ {N}_{subband}^{size} / 4 ⌋ , and - ⌊ {N}_{subband}^{size} / 2 ⌋ ,$$

in replace of

$$⌊ {N}_{BWP}^{size} / 2 ⌋ , ⌊ {N}_{BWP}^{size} / 4 ⌋ , and - ⌊ {N}_{BWP}^{size} / 2 ⌋ .$$

for the for the first resource allocation mode.
FIG. 7 shows an example procedure for the wireless terminal 30A which implements according to the existing 3GPP standard. In FIG. 7, as act 7-1 the UE firstly acquires system information including PUSCH configuration information. The PUSCH configuration information may include uplink bandwidth part, BWP, configuration information. The uplink BWP configuration information may include information on one or more UL BWPs. At least one of the one or more UL BWPs is an initial UL BWP. The UE configures the initial UL BWP as an active UL BWP. Act 7-2 comprises the wireless terminal 30B transmitting a PRACH in the active UL BWP. Act 7-3 comprises the 30B monitoring DCI with CRC scrambled by RA-RNTI within a certain time duration. If the UE detected DCI intended for wireless terminal 30B, wireless terminal 30B processes the DCI and acquires a RAR UL grant in the DCI. Act 7-4 comprises the wireless terminal 30B determining a frequency resource for PUSCH scheduled by the RAR UL grant. An example procedure of the frequency resource determination comprises of 1) frequency resource determination as indicated by a Resource Indication Value, RIV, and/or 2) frequency hopping determination.

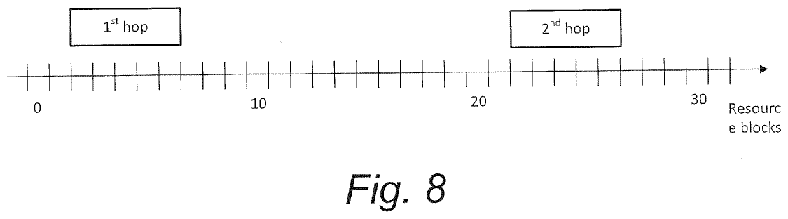

FIG. 8 shows an example procedure for a frequency resource determination as indicated by Resource Indication Value, RIV. In FIG. 8, the horizontal axis represents the resource block domain and grids represents boundary of two continuous resource blocks. In the frequency resource determination, the wireless terminal 30A firstly determines frequency resource by the Resource Indication Value, RIV. The RIV indicates starting resource block index and the number of continuous resource blocks. In FIG. 8, it is assumed that Resource Indication Value, RIV, indicates the starting resource block Index=2 and the number of continuous resource blocks=5. Therefore, the wireless terminal 30A determines the index N₁ₛₜ=2 to 6 as the frequency resource for the 1^{st} hop. The frequency resource determined by Resource Indication Value, RIV is also referred to herein as the 1^{st} hop or an initial resource. The RIV may be indicated to wireless terminal 30A via the RAR UL grant. For example, the RIV may be indicated to the UE via a frequency domain resource assignment field in the RAR UL grant.

Table 3 shows an example procedure of Resource Indication Value, RIV encoding. The wireless terminal 30A may determine the starting resource block RB start and the number of continuous resource blocks L_{RBs} from the value of RIV. For the determination, wireless terminal 30A assumes that RIV is encoded as in Table 3. As used herein, N^{size}_{BWP} represents the number of resource blocks in the initial UL BWP.

TABLE 3
RESOURCE INDICATION VALUE, RIV ENCODING

```
  $if ( {L}_{RBs} - 1 ) \leq ⌊ {N}_{BWP}^{size} / 2 ⌋ then$
    $RIV = {N}_{BWP}^{size} ( {L}_{RBs} - 1 ) + {RB}_{start}$
  else
    $RIV = {N}_{BWP}^{size} ( {N}_{BWP}^{size} - {L}_{RBs} + 1 ) + ( {N}_{BWP}^{size} - 1 - {RB}_{start} )$
where L_{RBs} ≥ 1 and shall not exceed ${N}_{BWP}^{size} - {RB}_{start} .$
```

For the example embodiment and mode of FIG. 5A the wireless terminal 30A next determines, in the frequency resource determination procedure, a 2nd hop in a case that frequency hopping is enabled for the PUSCH. In the 2^{nd} hop determination, wireless terminal 30A uses a frequency offset value Oₕₒₚ. The resource block index N_{2nd} in the 2^{nd} hop is determined by N_{2nd}=N₁ₛₜ+Oₕₒₚ. In FIG. 8, Oₕₒₚ=20 is assumed. Therefore, wireless terminal 30A determines the index N_{2nd}=22 to 26 as the frequency resource for the 2^{nd} hop. The value of Oₕₒₚ may be indicated via a part of the bits in the RAR UL grant. For example, the value of Oₕₒₚ may be indicated via a part of bits in the frequency domain resource assignment field in the RAR UL grant.

Table 4 shows an example of indication of the value of Oₕₒₚ via the part of bits. In Table 4, two examples are described. A first example is for a first case of N^{size}_{BWP} being smaller than 50. A second example is for a second case of N^{size}_{BWP} being equal to or larger than 50.

For the first case of Table 4, the number of bits to indicate the value of Oₕₒₚ is 1. In a case of the bit being 0, the frequency offset Oₕₒₚ is floor (N^{size}_{BWP}/2). In a case of the bit being 1, the frequency offset Oₕₒₚ is floor (N^{size}_{BWP}/4).

For the second case of Table 4, the number of bits to indicate the value of Oₕₒₚ is 2. In a case of the bit being 00, the frequency offset Oₕₒₚ is floor (N^{size}_{BWP}/2). In a case of the bit being 01, the frequency offset Oₕₒₚ is floor (N^{size}_{BWP}/4). In a case of the bit being 10, the frequency offset Oₕₒₚ is-floor (N^{size}_{BWP}/4). The code point 11 is reserved.

TABLE 4
INDICATION OF THE VALUE OF O_{HOP}

| Number of PRBs in | Value of N_{ULhop} | Frequency offset for 2^{nd} hop |
|---|---|---|
| initial UL BWP | Hopping Bits | |
| ${N}_{BWP}^{size} < 50$ | 0 | ${N}_{BWP}^{size} / 2$ |
| | 1 | ${N}_{BWP}^{size} / 4$ |
| ${N}_{BWP}^{size} \geq 50$ | 00 | ${N}_{BWP}^{size} / 2$ |
| | 01 | ${N}_{BWP}^{size} / 4$ |
| | 10 | $- {N}_{BWP}^{size} / 4$ |
| | 11 | Reserved |

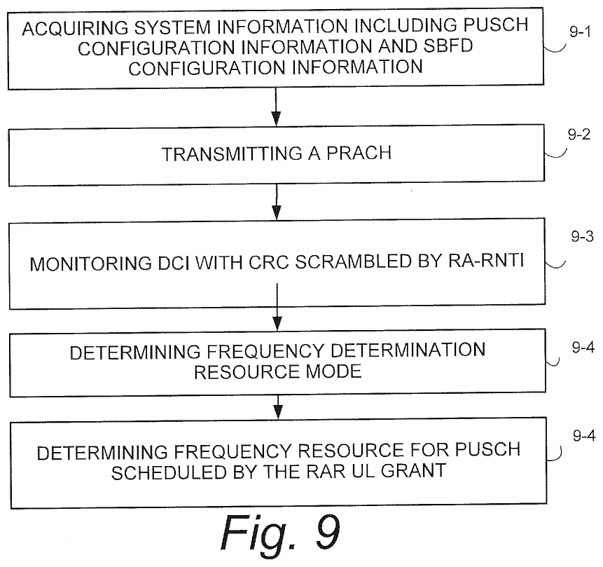

In contrast to FIG. 7, FIG. 9 is an example procedure of an enhanced wireless terminal, such as wireless terminal 30B. The enhanced wireless terminal may acquire SBFD configuration information from the system information in addition to the PUSCH configuration information. The SBFD configuration information, which was stored in SBFD memory 46 of the base station node and was broadcast to the wireless terminal 30B in system information, may include information to identify a UL subband. As act 9-1, if the information to identify a UL subband is included in the SBFD configuration information, the wireless terminal 30A determines the size and/or location of the UL subband by the information.

Act 9-2 and act 9-3 of FIG. 9 are similar to respective act 7-2 and act 7-3 of FIG. 7. Act 9-2 comprises the wireless terminal 30B transmitting a PRACH in the active UL BWP. Act 9-3 comprises the wireless terminal 30B monitoring DCI with CRC scrambled by RA-RNTI within a certain time duration. If the UE detected a DCI intended for wireless terminal 30B, wireless terminal 30B processes the DCI and acquires a RAR UL grant in a PDSCH scheduled by the DCI. Act 9-4 comprises the wireless terminal 30B determining a frequency resource for PUSCH scheduled by the RAR UL grant. An example procedure of the frequency resource determination comprises of 1) frequency resource determination as indicated by a Resource Indication Value, RIV, and/or 2) frequency hopping determination. In the procedure of the enhanced wireless terminal, after the wireless terminal acquired a RAR UL grant which includes a DCI, the wireless terminal may determine a frequency resource determination mode. For example, the wireless terminal may select one frequency resource determination mode among two modes. For example, one mode, i.e., the first frequency resource determination mode, is the same mode as described with Table 4, and the other mode, e.g., the second frequency resource determination mode is a mode described below. As act 9-5 the wireless terminal determines, in accordance with the selected resource allocation mode, a frequency resource for the physical uplink shared channel, PUSCH, as scheduled by the RAR UL grant.

In the second mode, the wireless terminal assumes the size of the UL subband as the value of N^{size}_{BWP} for a case of frequency hopping determination although the wireless terminal assumes the size of the initial UL BWP as the value of N^{size}_{BWP} for a case of frequency resource determination as indicated by RIV.

The wireless terminal may determine one frequency resource determination mode among the two frequency resource determination modes based on one or more of the following:
1) Time resource in which the PUSCH is scheduled
2) Frequency resource in which the PUSCH is scheduled
3) Indication in the RAR UL grant
4) PRACH resource used for the PRACH

For example, the wireless terminal may determine one frequency resource determination mode based on whether or not the time resource for the PUSCH overlaps with a certain region. For example, in a case that the time resource for the PUSCH overlaps with the certain region, the wireless terminal may determine the first frequency resource determination mode. For example, in a case that the time resource for the PUSCH does not overlap with the certain resource, the wireless terminal may determine the second frequency resource determination mode. For example, the certain region may be legacy UL region. For example, the certain region may be UL resource indicated via tdd-UL-DL-configurationCommon. Here, the tddUL-DL-configurationCommon is an information field indicating a TDD pattern and the tdd-UL-DL-configurationCommon is included in the system information.

For example, in a case that the time resource for the PUSCH is confined in a certain region, the wireless terminal may determine the second frequency resource determination mode. For example, in a case that the time resource for the PUSCH is not confined with the certain region, the wireless terminal may determine the first frequency resource determination mode. For example, the certain region may be SBFD region. For example, the certain region may be a region indicated by information in the system information where the information is different from the tddUL-DL-configurationCommon.

For example, the wireless terminal may determine one frequency resource determination mode based on whether or not the frequency resource for the 1st hop overlaps with DL subband. For example, in a case that the frequency resource for the 1st hop overlaps with DL subband, the wireless terminal may determine the first frequency resource determination mode. For example, in a case that the frequency resource for the 1st hop doesn't overlap with the DL subband, the wireless terminal may determine the second frequency resource determination mode. For example, in a case that the frequency resource for the 1st hop is confined with the UL subband, the wireless terminal may determine the second frequency resource determination mode. For example, in a case that the frequency resource for the 1st hop is not confined with the UL subband, the wireless terminal may determine the first frequency resource determination mode.

For example, frequency resource determination mode to be applied for the PUSCH may be indicated by RAR UL grant. For example, the wireless terminal may determine one frequency resource determination mode based on whether or not the PRACH resource is associated with SBFD indication. For example, in a case that the PRACH resource is not associated with SBFD indication, the wireless terminal may determine the first frequency resource determination mode. For example, in a case that the PRACH resource is associated with SBFD indication, the wireless terminal may determine the second frequency resource determination mode.

### C: Alignment of PUSCH Repetitions

The communications system 20 of the example embodiment and mode of FIG. 5C addresses, e.g., the second issue or problem described above, i.e., the problem relating to allocation of PUSCH repetition values. The structures, functionalities, and operations of the example embodiment and mode of FIG. 5B are essentially the same as those shown by corresponding reference numerals in the preceding figures, unless otherwise noted or evident from the context. In addition, FIG. 5C shows the resource mode memory 66 as storing different repetition values for the first resource allocation mode and the second resource allocation mode.

As mentioned above, PUSCH repetition is useful to enhance the communication coverage because overall transmission power for one PUSCH doubles when the UE performs transmission in two slots, e.g., two repetitions. However, if the wireless terminal transmits a PUSCH with two repetitions, e.g., in slot#3 and slot#4 in FIG. 4, for example, the frequency resource may change among the two repetitions. In such case, when the wireless terminal transmits the PUSCH repetition with different frequency resources, the wireless terminal is required to perform different signal generation procedure for each repetition.

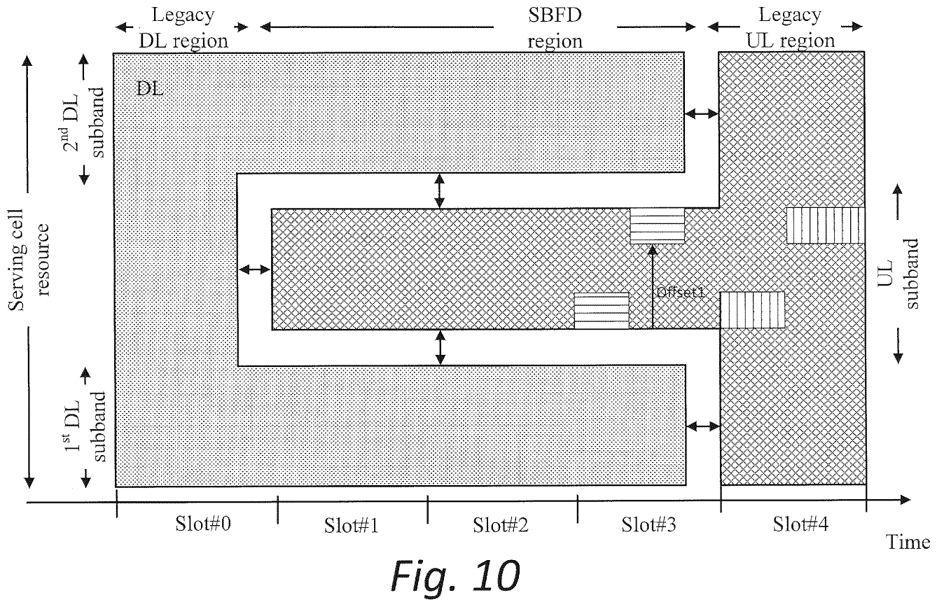

The example embodiment and mode of FIG. 5C solves the problem relating to PUSCH repetition values by virtue of the second resource allocation mode information being structured or configured such that the repetitions of PUSCH are aligned in the frequency domain, in the example manner shown in FIG. 10, thereby enhancing operation of the wireless terminal. FIG. 10 shows an example of frequency domain resource allocation for PUSCH with frequency hopping in a case of PUSCH repetition. In FIG. 10, the frequency resource of first repetition (horizontal hatching) and the second repetition (vertical hatching) may be aligned relative to frequency, e.g., along the frequency axis, or resource block index.

For PUSCH repetition, frequency resource alignment in the example manner of FIG. 10 may reduce the implementation complexity for the wireless terminal. In FIG. 10, there is a first PUSCH resource allocation, i.e., a first repetition, in slot#3 and a second PUSCH resource allocation, a second repetition in slot#4. In FIG. 10, “offset” means the frequency domain offset between the first hop and the second hop, e.g., between the first and second hatched blocks in the same slot. For example, in an example embodiment and mode the wireless terminal may determine an offset in slot#3, which shall be referred to as the “first offset”, and an offset in slot#4, which shall be referred to as the “second offset”, based on whether at least one repetition of the uplink channel is in the SBFD region or not. For example, in a case that at least one repetition of PUSCH is in the SBFD region, the wireless terminal determines the first offset in slot#3 and the second offset in slot#4 to have a same offset value “offset1” as shown in FIG. 10. On the other hand, in a case that none of the repetitions of the uplink channel is in the SBFD region, the wireless terminal determines the offset in slot#3 and the offset slot#4 to have the offset value of “offset2” in the manner shown in FIG. 4. While FIG. 4 does show the offset value “offset2”, FIG. 4 does not show the case just described in which both slot#3 and slot#4 has having the same offset value “offset2”. Thus, in a case that none of repetitions are in SBFD region (i.e., all repetitions are in legacy UL region), the wireless terminal selects an offset value of offset2 for all repetitions.

For the specific example shown in FIG. 10, the resource allocation mode selector 64:
may select the second offset value “offset2” when all repetitions of the PUSCH is in the legacy region;
may select the first offset value “offset1” when all repetitions of the PUSCH is in the legacy region;
may not select the first offset value when at least one repetition of the PUSCH is in the SBFD region, since in such case the PUSCH would be allocated in a DL resource region.

Thus, the first resource allocation mode may be structured to provide offsets such as those shown in FIG. 4 in a situation in which none of the repetitions of the uplink channel is in the SBFD region, whereas the second resource allocation mode may be structured to provide offsets such as those shown in FIG. 10 in a situation in which one of the repetitions of the uplink channel is in the SBFD region. The resource allocation mode selector 64 therefore may select between the first resource allocation mode and the second resource allocation mode using dependency criteria as herein discussed.

The example embodiment and mode of FIG. 5C may be utilized in conjunction with the example embodiment and mode of FIG. 5B. In the example embodiment and mode of FIG. 5B, a base station may provide two offset values by RRC signaling and the wireless terminal selects from among the two offset values based, e.g., on whether the PUSCH is in the SBFD region or not. In a case that the PUSCH is scheduled with repetitions, as in the example embodiment and mode of FIG. 5C, the wireless terminal may similarly select offset values based, e.g., on whether at least one repetition is in the SBFD region or not.

Describing the example embodiment and mode of FIG. 5C in detail, in a case that at least one PUSCH repetition is in the SBFD region, the wireless terminal selects an offset value as provided in the second resource allocation mode so that the offset values are frequency aligned, and in a case that none of one PUSCH repetition is in the SBFD region, the wireless terminal selects an offset value as provided in the first resource allocation mode, where the frequency values need not necessarily be frequency aligned.

The foregoing assumes that the wireless terminal has been already provided SBFD configuration, e.g., in system information. However, it is possible that the SBFD configuration could also be provided by UE-specific RRC configuration after initial connection establishment. Therefore, consideration for procedure in the wireless terminal before initial connection establishment should be made, as herein after discussed.

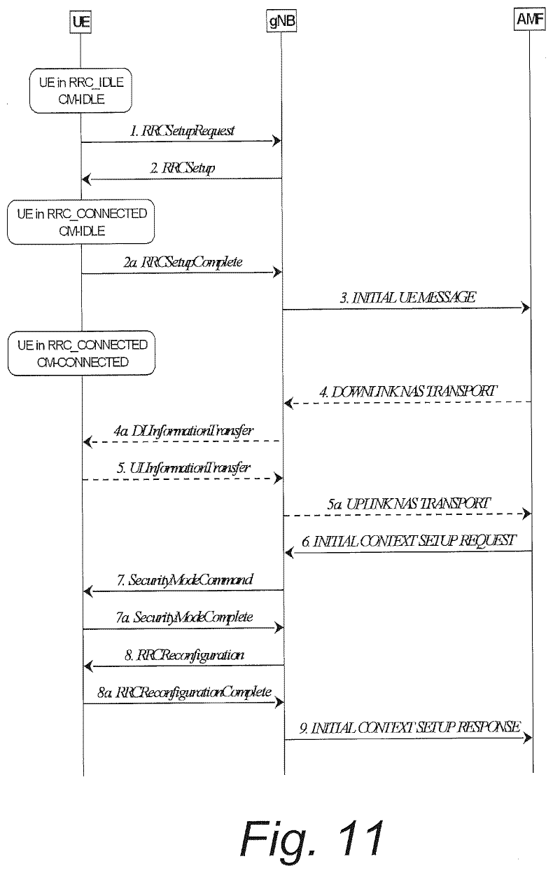

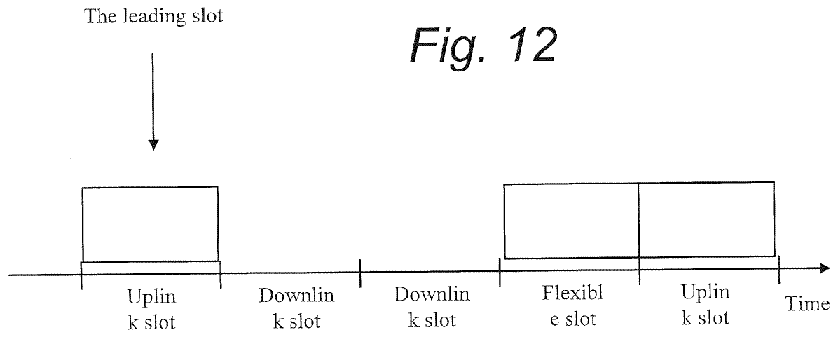

FIG. 11 is an example of initial connection establishment specified in FIG. 9.2.1.3-1 of 3GPP TS38.300. In the FIG. 11, the wireless terminal obtains a UE-specific RRC configuration in an information element RRCReconfiguration as in Step 8 of FIG. 11. Therefore, if the SBFD configuration is provided in RRCReconfiguration, the consideration should be made for the UE before RRCReconfiguration and after RRCReconfiguration.

For the wireless terminal before RRC connection, PUSCH transmission could be categorized as follows:
1) PUSCH scheduled by RAR UL grant for msg3
2) PUSCH scheduled by DCI format 0_0 for msg3 retransmission
3) PUSCH scheduled by DCI format 0_0

For the UE before RRC connection, two cases can be studied:
Case1) the UE doesn't transmit PUSCH in SBFD duration
Case2) the UE transmits PUSCH in SBFD duration

In Case1, the base station should not schedule PUSCH transmission in the SBFD region. However, the restriction cannot be made for PUSCH with repetition.

As used therein, the UE determines repetitions for PUSCH repetition with the following steps:
Step1) The UE detects a DCI format or random access response grant for a PUSCH with repetition
Step2) The UE determines leading slot for the PUSCH repetition by using a value in time domain resource assignment field in the DCI format, and determines the number K of repetitions for the PUSCH repetition by using a value in the time domain resource assignment field
Step3) The UE counts K available slots starting at the leading slot
   FIG. 12 shows an example of available slot counting. In the available slot counting, the UE first determines the leading slot. The leading slot may be determined based on K1 value indicated via time domain resource assignment field in the DCI format which schedules a PUSCH. The UE also determines the number K of repetitions via the time domain resource assignment field. Then, the UE counts K available slots starting at the leading slot, where the available slots may be flexible slot or uplink slot. In FIG. 12, assuming K=3, the UE counts 3 slots including the uplink slot as the leading slot and subsequent flexible slot and uplink slot.

Therefore, if the base station utilizes downlink slots for SBFD, since the PUSCH repetition cannot be mapped to downlink slots, the latency would be much higher. Further, if the base station utilizes flexible slots for SBFD, the base station cannot control the frequency domain resource allocation because the UE before RRC connection does not know the size and location of UL subband.

Thus, in a case that the PUSCH is transmitted with repetitions, the wireless terminal may determine one frequency resource determination mode by checking some or all repetitions. For example, the wireless terminal may determine one frequency resource determination mode based on whether or not the time resource at least for one repetition of the repetitions overlaps with a certain region. For example, in a case that the time resource at least for one repetition of the repetitions overlaps with the certain region, the wireless terminal may determine the first frequency resource determination mode. For example, in a case that the time resource for any repetitions does not overlap with the certain resource, the wireless terminal may determine the second frequency resource determination mode. For example, the certain region may be legacy UL region. For example, the certain region may be UL resource indicated via tddUL-DL-configurationCommon.

For example, in a case that the time resource at least for one repetition of the repetitions is confined in a certain region, the wireless terminal may determine the second frequency resource determination mode. For example, in a case that the time resource for any repetitions is not confined with the certain region, the wireless terminal may determine the first frequency resource determination mode. For example, the certain region may be SBFD region. For example, the certain region may be a region indicated by information in the system information where the information is different from the tdd-UL-DL-configurationCommon.

For example, the wireless terminal may determine one frequency resource determination mode based on whether or not the frequency resource for the 1^{st} hop overlaps with DL subband. For example, in a case that the frequency resource at least for the 1^{st} hop in one repetition of the repetitions overlaps with DL subband, the wireless terminal may determine the first frequency resource determination mode. For example, in a case that the frequency resource for the 1^{st} hop in any repetitions does not overlap with the DL subband, the wireless terminal may determine the second frequency resource determination mode. For example, in a case that the frequency resource at least for the 1^{st} hop in one repetition of the repetitions is confined with the UL subband, the wireless terminal may determine the second frequency resource determination mode. For example, in a case that the frequency resource for the 1st hop in any repetitions is not confined with the UL subband, the wireless terminal may determine the first frequency resource determination mode.

### 3.0 Selection of Subband Configuration Information

As mentioned above, a third issue or problem may be that a base station cannot control the frequency domain resource allocation for the wireless terminal before RRCReconfiguration because the wireless terminal does not know the size and location of UL subband.

An example of this third issue or problem is that in some instances a wireless terminal may have differing Sub-Band Full Duplex, SBFD, configurations and may not know which to select. For example, a base station may provide a first SBFD configuration information in system information or common RRC signaling before the wireless terminal is reconfigured, e.g., before RRCReconfiguration. For example, an IDLE mode wireless terminal may determine the first SBFD configuration via the first SBFD configuration information. The first SBFD configuration information: (1) may be information different from BWP configuration information; (2) may include information indicating first type of UL subband; and/or (3) may include information indicating first type of DL subband. In such situation, the wireless terminal can determine appropriate frequency domain resource to use for PUSCH by using the SBFD configuration which has been received via the common RRC signaling before the RRCReconfiguration. For example, size and/or location of first type of UL subband may be obtained via information for configuring control resource set with index 0. For example, size of first type of UL subband may be determined based on size of control resource set with index 0. For example, location of first type of UL subband may be determined based on length of control resource set with index 0.

On the other hand, upon performance of an RRCReconfiguration operation, the wireless terminal may receive a second SBFD configuration information via UE-specific RRC signaling in the RRCReconfiguration message.

That is, a RRC connected mode wireless terminal may obtain second SBFD configuration information via RRC reconfiguration procedure. The RRC connected mode wireless terminal may determine a second SBFD configuration via the second SBFD configuration information. Therefore, after the RRCReconfiguration the wireless terminal has two SBFD configurations: a first SBFD configuration received before reconfiguration via system information or common signaling, and a second SBFD configuration received after reconfiguration via UE-specific RRC signaling. In such case the wireless terminal may not know which of the first SBFD configuration and the second SBFD configuration the wireless terminal should select or use.

Therefore, in the example embodiment and mode of FIG. 5D the wireless terminal is provided or configured with additional rules to select between plural SBFD configurations. In the example embodiment and mode of FIG. 5D, the wireless terminal 30D manages a selection of the first SBFD configuration and the second SBFD configuration The structures, functionalities, and operations of the example embodiment and mode of FIG. 5C are essentially the same as those shown by corresponding reference numerals in the preceding figures, unless otherwise noted or evident from the context. In addition, FIG. 5C shows that the resource manager 62 may additional comprise SBFD configuration memory 80 which may store plural SBFD configurations, such as the first SBFD configuration information and the second SBFD configuration information described above by way of unlimiting example, as well as SBFD configuration selector 82.

In an example embodiment and mode, the SBFD configuration selector 82 may select between the plural SBFD configurations stored in SBFD configuration memory 80 based on specified criteria. For example, the SBFD configuration selector 82 may determine one SBFD configuration based or dependent on scheduling type. For example, in a case that a PUSCH is scheduled for the wireless terminal by a first scheduling type, the wireless terminal may select the first SBFD configuration, or in a case that a PUSCH is scheduled for the wireless terminal by a second scheduling type, the wireless terminal may select the second SBFD configuration.

Thus, in the example embodiment and mode of FIG. 5D the SBFD configuration selector 82 serves to select between a first resource allocation mode, e.g., the first SBFD configuration information, and a second resource allocation mode, e.g., the second SBFD configuration information.

As non-limiting examples of scheduling type:
the first scheduling type may include scheduling by DCI format 0_0 with CRC sequence scrambled by C-RNTI
the first scheduling type may include scheduling by DCI format 0_1/0_2.
the second scheduling type may include scheduling by random access response grant
the second scheduling type may include scheduling by DCI format 0_0 with CRC sequence scrambled by TC-RNTI.
   Thus far the discussion of the FIG. 5D example embodiment and mode has presumed that the wireless terminal receives information indicating the size and location of the uplink subband. However, as a variation of the example embodiment and mode of FIG. 5D, the wireless terminal may determine a SBFD configuration to use by simply using an existing configuration. For example, an existing configuration may be size and location of the UL subband based on the size and location of the control resource set where the control resource set represents the bandwidth of the control signaling. For example, the wireless terminal may determine the size of the UL subband by the size of control resource set with index 0 provided by system information. For example, the wireless terminal may determine the location of the UL subband by the location of the control resource set with index 0. In the time domain, the wireless terminal may determine flexible slots as unavailable slots.

### E: Frequency Hopping for PUCCH in SBFD

Transmission of a physical uplink control channel, PUCCH, is triggered by downlink control information (DCI) for scheduling a physical downlink shared channel, PDSCH. For example, the base station triggers a transmission of a PUCCH via DCI. The DCI includes a PUCCH resource indicator field which is used to indicate a PUCCH resource for transmission. The wireless terminal determines a PUCCH resource based on the value of the PUCCH resource indicator field.

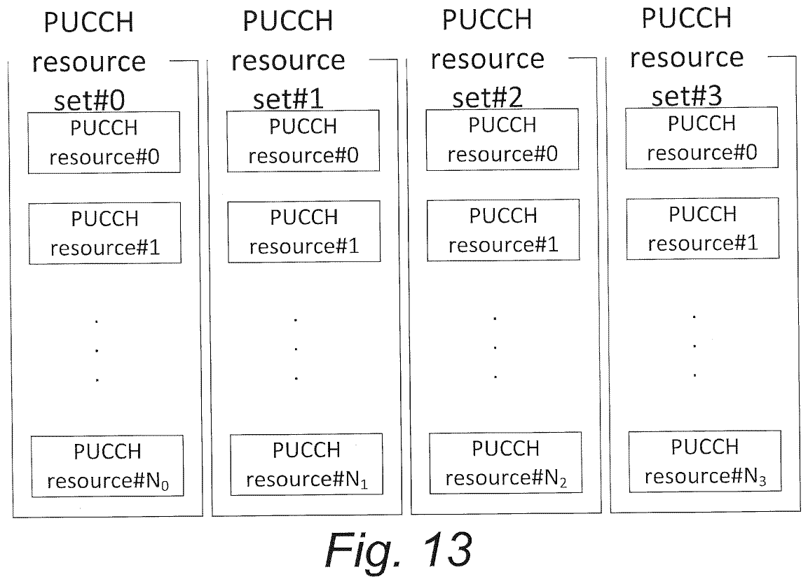

FIG. 13 is an example configuration of PUCCH resources. FIG. 13 shows four PUCCH resource sets (PUCCH resource set#0˜3). Each PUCCH resource set of FIG. 13 may be associated with a range of values for the number of uplink control information, UCI, bits. For example: PUCCH resource set#0 may be associated with up to 2 bits of UCI; PUCCH resource set#1 may be associated with a range from 3 bits to 10 bits; PUCCH resource set#2 may be associated with a range from 11 bits to 17 bits; PUCCH resource set#3 may be associated with above 17 bits. On the other hand, the range associated with each PUCCH resource set may be provided by RRC signaling. Further, it should be noted that the number of PUCCH resource sets may be 4 or another number. For example, the number of PUCCH resource sets may be provided by RRC signaling.

PUCCH resource set#p (p takes 0, 1, 2 or 3 in FIG. 13) includes Np PUCCH resources where an index is attached to each PUCCH resources in PUCCH resource set#p. The index can be set to identify PUCCH resources among a PUCCH resource set.

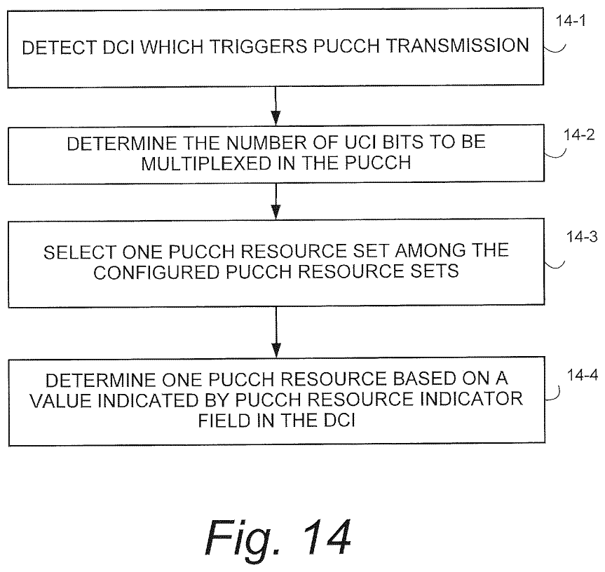

FIG. 14 is an example procedure for PUCCH resource determination. Firstly, as act 14-1, the wireless terminal detects DCI which triggers a PUCCH transmission. For example, the DCI may be DCI for scheduling a PDSCH. Next, as act 14-2, the wireless terminal determines the number of UCI bits to be multiplexed in the PUCCH. For example, the wireless terminal determines the number of HARQ-ACK bits based on a value of DAI (Downlink Assignment Index) field. Next, as act 14-3, the wireless terminal selects one PUCCH resource set among the configured PUCCH resource sets based on the determined number of UCI bits. For example, in FIG. 13, the wireless terminal may select PUCCH resource set#2 in a case that the determined number of UCI bits is 16. This is because 16 is covered by the range associated with PUCCH resource set#2. Next, as act 14-4, the wireless terminal selects one PUCCH resource among the PUCCH resources in the determined PUCCH resource set. A value indicated by PUCCH resource indicator field in the DCI may be used to determine the PUCCH resource. For example, the value may indicate an index of the PUCCH resource.

Summarizing and amplifying some of the foregoing, Each PUCCH resource includes configuration for enabling/disabling of frequency hopping, e.g.: a starting PRB index for the 1^{st} hop, and a starting PRB index for the 2^{nd} hop.

Thus, in terms of resource allocation for hopping, the physical uplink control channel, PUCCH, has similar issues as the physical uplink shared channel, PUSCH, as described above in section E. In other words, an appropriate way of determining an offset for PUCCH is needed.

The communications system 20 of the example embodiment and mode of FIG. 5E addresses, e.g., the fourth issue or problem described above, i.e., that frequency hopping for a PUCCH may not work properly in the SBFD region. The structures, functionalities, and operations of the example embodiment and mode of FIG. 5E are essentially the same as those shown by corresponding reference numerals in the preceding figures, unless otherwise noted or evident from the context. In addition, FIG. 5E shows the resource mode memory 66 as storing either different frequency hopping offset values for the first resource allocation mode and the second resource allocation mode for PUCCH, or different sets of PUCCH resources for differing resource allocation modes.

The wireless terminal of FIG. 5E may operate according to various sub-embodiments and modes, two of which are discussed below:
1) Sub-embodiment 1: A single set of PUCCH resources is configured for a single value range of UCI payload size, where each PUCCH resource is configured with separate starting PRB index for SBFD region and starting PRB index for legacy UL region in case of frequency hopping
2) Sub-embodiment 2: Two sets of PUCCH resources are configured for a single value range of UCI payload size. One set is selected for each PUCCH transmission.

In sub-embodiment 1 a single set of PUCCH resources associated with a single value range of UCI size is configured. It is preferable to set more than 3 bits of PUCCH resource indicator field where the existing 3GPP standard supports 3 bits of PUCCH resource indicator field. Therefore, the gNB may set X bits (X may be larger than 3) of PUCCH resource indicator field in a case that SBFD is configured to the UE, and the gNB may set 3 bit of PUCCH resource indicator field in a case that SBFD is configured to the UE.

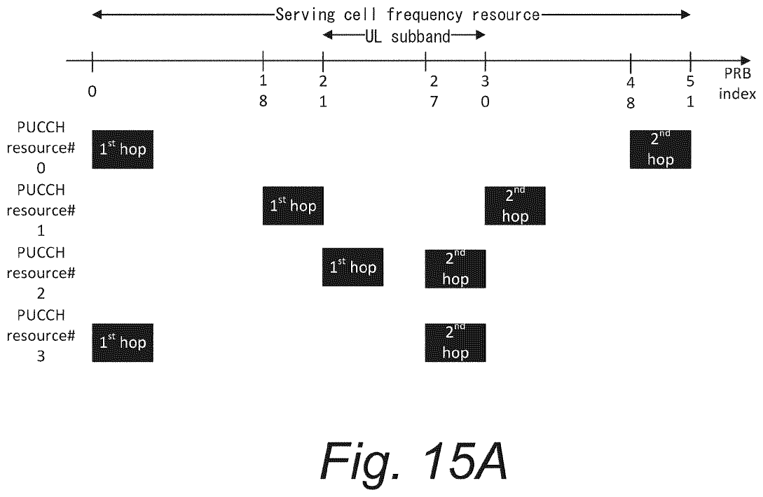

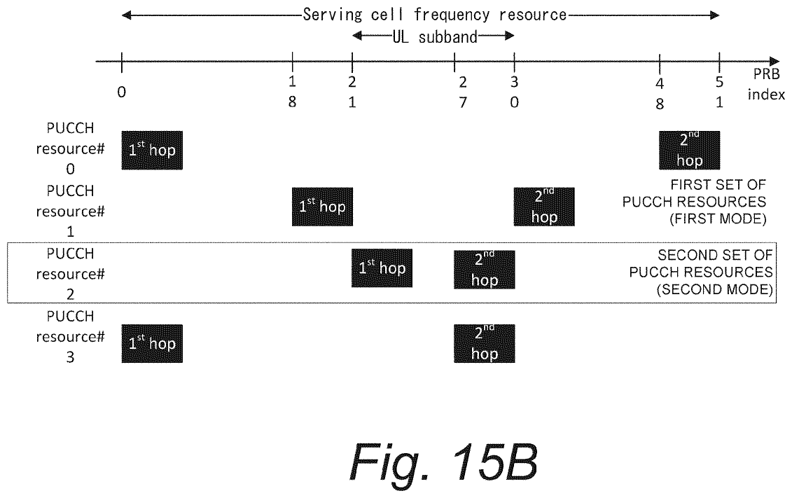

An example, non-limiting illustration of sub-embodiment 1 is illustrated in FIG. 15A. In FIG. 15A example membership a single set of PUCCH resources is as follows:
PUCCH resource#0
PUCCH resource#1
PUCCH resource#2
PUCCH resource#3

For example, each PUCCH resource of the single set of FIG. 15A may one or more of the following properties:
Indication of applied format
Starting PRB index for the 1st hop
Starting PRB index for the 2nd hop
   For example, applicable values for indication of applied format could be 0 to 4. The applicable values indicate used PUCCH format.

For example, the value range of starting PRB index for the 1st hop could be 0 to N^{size}_{BWP} where N^{size}_{BWP} is the number of PRBs in the UL BWP.

FIG. 15A thus shows an example of possible values for each PUCCH resource. In FIG. 15A it is assumed that the number of PRBs, which is configured for each PUCCH format, is four for all PUCCH formats, the number of resource blocks in the serving cell frequency resource is 51, location and size of the UL BWP is the same as the serving cell frequency resource, and the number of resource blocks in the UL subband is 10.

The starting PRB index for the 1^{st} hop for PUCCH resource#0 is 0 and the starting PRB index for the 2ⁿd hop for PUCCH resource#0 is 48 where the PUCCH resource#0 is applicable to legacy UL region.

The starting PRB index for the 1^{st} hop for PUCCH resource#1 is 18 and the starting PRB index for the 2^{nd} hop for PUCCH resource#1 is 30 where the PUCCH resource#1 is applicable to legacy UL region.

The starting PRB index for the 1^{st} hop for PUCCH resource#2 is 21 and the starting PRB index for the 2^{nd} hop for PUCCH resource#2 is 27 where the PUCCH resource#2 is applicable to legacy UL region and SBFD region.

The starting PRB index for the 1^{st} hop for PUCCH resource#3 is 0 and the starting PRB index for the 2^{nd} hop for PUCCH resource#3 is 27 where the PUCCH resource#3 is applicable to legacy UL region.

The foregoing shows that in the first sub-mode of the example embodiment and mode of FIG. 5E the first parameter associated with a PUCCH resource indicates a first starting PRB index for a hop of the PUCCH and the second parameter associated with the PUCCH resources indicates a second starting PRB index for the hop of the PUCCH, with the first index and the second index having different values.

Thus, in the example embodiment and mode of FIG. 5E, the resource allocation mode selector 64 selects between the first resource allocation mode, i.e., resources in the set that have appropriate hop indices for the legacy UL region, and the second resource allocation mode, resources of the single set that have appropriate hop indices for the Sub-Band Full Duplex, SBFD region.

In Sub-embodiment 2, two sets of PUCCH resources are associated with a single value range of UCI size. For example, one PUCCH resource set is a PUCCH resource set for SBFD region, and the other PUCCH resource set is a PUCCH resource set for legacy UL region. The UE may determine one PUCCH resource set among the two PUCCH resource sets.

FIG. 15B is similar to FIG. 15A, but whereas FIG. 15A shows one set of PUCCH resources, FIG. 15B shows two sets of PUCCH resources. In FIG. 15A the first set of PUCCH resources are the PUCCH resources which are outside of the broken line box which is depicted as “Second Set”, whereas the second set of PUCCH resources are the PUCCH resources which are within the broken line box which is depicted as “Second Set”. In other words, the first set of PUCCH resources are resource#0, resource#1, and resource#3, and the second set of PUCCH resources include only resource#2. Therefore, in the second sub-embodiment of FIG. 5E the resource allocation mode selector 64 selects between the first resource allocation mode, i.e., the first set of PUCCH resources, and the second resource allocation mode, i.e., the second set of PUCCH resources.

In an example manner of operation, the wireless terminal may determine two PUCCH resource sets based on the associated value range and the number of UCI bits. Then, the wireless terminal may determine one PUCCH resource set among the two based on one of the following examples: (1) Time resource in which the PUCCH resource is located; or (2) Indication in the DCI.

In an example manner of operation, the wireless terminal may determine one PUCCH resource set based on whether or not the time resource in which the PUCCH resource is located overlaps with the certain region. For example, in a case that the time resource in which the PUCCH resource is located overlaps with the certain region, the wireless terminal may determine first PUCCH resource set where the first PUCCH resource set is associated with a single value range. For example, in a case that the time resource in which the PUCCH resource is located doesn't overlap with the certain region, the wireless terminal may determine second PUCCH resource set where the second PUCCH resource set is associated with the single value range. For example, the certain region may be legacy UL region. For example, the certain region may be UL resource indicated via tdd-UL-DL-configurationCommon. Here, the tddUL-DL-configurationCommon is an information field indicating a TDD pattern and the tdd-UL-DL-configurationCommon is included in the system information.

In an example manner of operation, in a case that the time resource in which the PUCCH resource is located is confined in a certain region, the wireless terminal may determine the second PUCCH resource set. For example, in a case that the time resource in which the PUCCH resource is located is not confined in a certain region, the wireless terminal may determine the first PUCCH resource set. For example, the certain region may be SBFD region. For example, the certain region may be a region indicated by information in the system information where the information is different from the tdd-UL-DL-configurationCommon.

In an example manner of operation, the wireless terminal may determine one PUCCH resource set based on an indication in the DCI which triggers PUCCH transmission. For example, the wireless terminal may determine the first PUCCH resource set among the two in a case that a bit in the DCI other than bits in the PUCCH resource indicator field is a first value (e.g., 0). For example, the wireless terminal may determine the second PUCCH resource set among the two in a case that the bit in the DCI other than bits in the PUCCH resource indicator field is a second value (e.g., 1).

In an example manner of operation, if the PUCCH is configured as repetition, the repetitions other than the first repetition may follow the same PUCCH resource.

In an example manner of operation, if the PUCCH is configured as repetition, PUCCH resource for each repetition may be determined based on whether or not the time resource in which the repetition is located overlaps with the certain region.

For a wireless terminal in RRC IDLE mode, for example, PUCCH resource indicator in a DCI format which triggers transmission of a PUCCH could be used to indicate one offset among the two. For example, each PUCCH resource in a PUCCH resource set can be associated with one offset.

For example, two different PUCCH resource sets can be configured to the wireless terminal. The wireless terminal can select one PUCCH resource set based on whether the PUSCH is in the SBFD region or not.

Sub-embodiment 1 and sub-embodiment 2 can be applied to fallback DCI as well because fallback DCI format also includes PUCCH resource indicator.

5.0 PUCCH Msg4 Information within the UL Subband

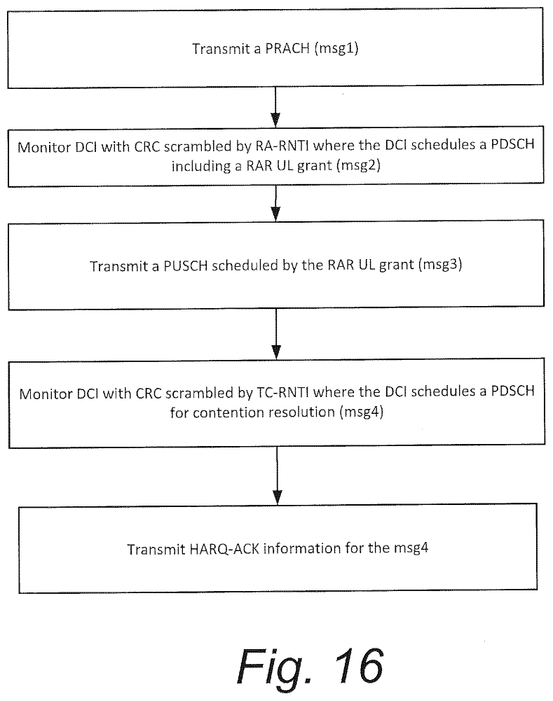

In a random access procedure a wireless terminal typically performs acts such as those shown in FIG. 16. The random access procedure may involve at least a part or all of four messages: message 1 (msg1), message 2 (msg2), message 3 (msg3), and message 4 (msg4). These messages are discussed briefly below:

Message 1 is a procedure in which the terminal device 1 transmits a PRACH. The terminal device 1 transmits the PRACH in one PRACH resource selected from among one or more PRACH resources based on at least the index of the SS/PBCH block candidate detected based on the cell search.

Message 2 is a procedure in which the terminal device 1 attempts to detect a DCI format 1_0 with CRC (Cyclic Redundancy Check) scrambled by an RA-RNTI (Random Access-Radio Network Temporary Identifier). The terminal device 1 may attempt to detect the DCI format 1_0 in a search-space-set.

Message 3 is a procedure for transmitting a PUSCH scheduled by a random-access response grant (RAR UL grant) included in the DCI format 1_0 detected in the message 2 procedure. The random-access response grant is indicated by the MAC CE included in the PDSCH scheduled by the DCI format 1_0.

The PUSCH scheduled based on the random-access response grant is either a message 3 PUSCH or a PUSCH. The message 3 PUSCH contains a contention resolution identifier MAC CE. The contention resolution ID MAC CE includes a contention resolution ID.

Retransmission of the message 3 PUSCH is scheduled by DCI format 0_0 with CRC scrambled by a TC-RNTI (Temporary Cell-Radio Network Temporary Identifier).

Message 4 is a procedure that attempts to detect a DCI format 1_0 with CRC scrambled by either a C-RNTI (Cell-Radio Network Temporary Identifier) or a TC-RNTI. The terminal device 1 receives a PDSCH scheduled based on the DCI format 1_0. The PDSCH may include a collision resolution ID.

The UE transmits HARQ-ACK information for the msg4 in a PUCCH where the PUCCH is triggered by the DCI format 1_0 with TC-RNTI.

Further, a PRACH is constructed as follows: A PRACH may be used to transmit a random-access preamble. The PRACH may be used to convey a random-access preamble. The sequence x_{u, v} (n) of the PRACH is defined by x_{u, v} (n)=xᵤ (mod(n+Cᵥ, L_{RA})). The xᵤ may be a ZC sequence (Zadoff-Chu sequence). The xᵤ may be defined by xᵤ=exp(−jpui (i+1)/L_{RA}). The j is an imaginary unit. The p is the circle ratio. The Cᵥ corresponds to cyclic shift of the PRACH. L_{RA} corresponds to the length of the PRACH. The L_{RA} may be 839 or 139 or another value. The i is an integer in the range of 0 to L_{RA}−1. The u is a sequence index for the PRACH. The terminal device 1 may transmit the PRACH. The base station device 3 may receive the PRACH.

For a given PRACH opportunity (PRACH resource, PRACH occasion), 64 random-access preambles are defined. The random-access preamble is specified (determined, given) at least based on the cyclic shift Cv of the PRACH and the sequence index u for the PRACH.

For a physical uplink control channel, PUCCH which conveys HARQ-ACK information for msg4, offset values are predefined in the existing 3GPP standard, which is similar situation as for PUSCH scheduled by RAR UL grant. In the current standard, the resource block index in the first hop and the resource block index in the second hop are determined by value r_{PUCCH}. As used herein, the value r_{PUCCH} is determined at least based on the value of PUCCH resource indicator field in the DCI format.

For example, the resource block index in the first hop for the PUCCH can be determined by RB^{offset}_{BWP}+floor(r_{PUCCH}/N_{CS}) where RB^{offset}_{BWP} and N_{CS} are determined by Table 5. As used herein, N_{CS} is the number of initial CS indexes. An index is configured for the UE (e.g., via SIB1) and the UE selects one row based on the index.

TABLE 5
PARAMETER SET FOR PUCCH CONVEYING HARQ-ACK
INFORMATION FOR msg4

| | PUCCH | First | Number of | PRB offset | Set of initial |
|---|---|---|---|---|---|
| Index | format | symbol | symbols | ${RB}_{BWP}^{offset}$ | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 1 | 10 | 4 | {0, 3, 6, 9} |
| 11 | 1 | 0 | 14 | 0 | {0, 6} |
| 12 | 1 | 0 | 14 | 0 | (0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | ${N}_{BWP}^{size} / 4$ | {0, 3, 6, 9} |

If an UL BWP with the same size and location as the serving cell resource is assumed, the resource block index for the first hop would not be confined with the UL subband due to the small range of values for RB^{offset}_{BWP}+floor(r_{PUCCH}/N_{CS}). If the row corresponding to the index 0 in Table 5 is selected, the value range of RB^{offset}_{BWP}+floor(r_{PUCCH}/N_{CS}) is 0 to 3. On the other hand, the resource block index 0 to 3 corresponds to the lower edge of the serving cell resource, which is not within the UL subband.

Thus, a fifth issue or problem addressed herein is that the frequency resource for PUCCH conveying msg4 HARQ-ACK information cannot be confined within the UL subband. As a solution, the example embodiment and mode of FIG. 5F provides apparatus and method to confine the PUCCH resource within the UL subband when necessary. The structures, functionalities, and operations of the example embodiment and mode of FIG. 5F are essentially the same as those shown by corresponding reference numerals in the preceding figures, unless otherwise noted or evident from the context. In addition, FIG. 5F shows the resource mode memory 66 as storing different 1^{st} hop determination modes for a physical uplink control channel, PUCCH, conveying msg4 HARQ-ACK information

The frequency resource for the first hop of PUCCH conveying msg4 HARQ-ACK information may be determined based on the location of the UL subband. For example, the wireless terminal may assume that the resource block index provided by a first calculation (i.e., RB^{offset}_{BWP}+floor(r_{PUCCH}/N_{CS})) is defined as starting at the resource block with the lowest frequency (i.e., starting resource block) within the UL subband.

For example, the resource block index of the first hop may be calculated by a third calculation RB^{offset}_{BWP}+floor(r_{PUCCH}/N_{CS})+N^{start}_{UL,subband} where N^{start}_{UL,subband} represents the starting resource block in the UL subband.

For example, frequency resource for the second hop of the PUCCH conveying msg4 HARQ-ACK information may be determine based on one or both of the location of the UL subband and the size of the location of the UL subband. For example, the wireless terminal may assume that the resource block index provided by fourth calculation N^{size}_{UL,subband}−1−RB^{offset}_{BWP}−floor(r_{PUCCH}/N_{CS}) is defined as starting at the resource block with the lowest frequency (i.e., starting resource block) within the UL subband.

For example, the resource block index of the first hop may be calculated by a fifth calculation N^{start}_{UL,subband}+N^{size}_{UL,subband}−1−RB^{offset}_{BWP}−floor(r_{PUCCH}/N_{CS}).

If the row with index 15 is used for determining one PUCCH resource set, the value of PRB offset may be determined based on the size of the UL subband. For example, the wireless terminal may determine the value of PRB offset by sixth calculation floor (N^{size}_{UL,subband}/4).

The wireless terminal may determine one determination mode for the 1^{st} hop among the two modes based on one or more of the following:
1) Time resource in which the PUCCH resource is located
2) Indication in the DCI
3) PRACH resource used for the PRACH
   in the example embodiment and mode of FIG. 5F, a first determination mode for the 1^{st} hop may be the following:
1) Calculating resource block index by the first calculation and assuming resource block index is defined as starting at the resource block with lowest frequency within the serving cell frequency resource.
   In the example embodiment and mode of FIG. 5F, a second determination mode for the 1^{st} hop is one of the following:
1) Calculating resource block index by the first calculation and assuming resource block index is defined as starting at the resource block with lowest frequency within the UL subband
2) Calculating resource block index by the third calculation and assuming resource block index is defined as starting at the resource block with lowest frequency within the serving cell frequency resource.
   For example, the wireless terminal may determine one determination mode for the 1^{st} hop based on whether or not the time resource in which the PUCCH resource is located overlaps with the certain region. For example, in a case that the time resource in which the PUCCH resource is located overlaps with the certain region, the wireless terminal may determine the first determination mode for the 1^{st} hop. For example, in a case that the time resource in which the PUCCH resource is located doesn't overlap with the certain region, the wireless terminal may determine the second determination mode for the 1^{st} hop. For example, the certain region may be legacy UL region. For example, the certain region may be UL resource indicated via tddUL-DL-configurationCommon. Here, the tdd-UL-DL-configurationCommon is an information field indicating a TDD pattern and the tdd-UL-DL-configurationCommon is included in the system information.

For example, in a case that the time resource in which the PUCCH resource is located is confined in a certain region, the UE may determine the second determination mode for the 1^{st} hop. For example, in a case that the time resource in which the PUCCH resource is located is not confined in a certain region, the UE may determine the first determination mode for the 1^{st} hop. For example, the certain region may be SBFD region. For example, the certain region may be a region indicated by information in the system information where the information is different from the tddUL-DL-configurationCommon.

For example, the UE may determine one determination mode for the 1^{st} hop based on indication in the DCI. For example, the UE may determine the first determination mode for the 1^{st} hop among the two in a case that a bit in the DCI other than bits in the PUCCH resource indicator field is a first value (e.g., 0). For example, the UE may determine the second determination mode for the 1^{st} hop among the two in a case that the bit in the DCI other than bits in the PUCCH resource indicator field is a second value (e.g., 1).

For example, the wireless terminal may determine one determination mode for the 1^{st} hop based on whether or not the PRACH resource is associated with SBFD indication. For example, in a case that the PRACH resource is not associated with SBFD indication, the wireless terminal may determine the first determination mode for the 1^{st} hop. For example, in a case that the PRACH resource is associated with SBFD indication, the wireless terminal may determine the second determination mode for the 1^{st} hop.

Thus, the example embodiment and mode of FIG. 5F may be implemented in various sub-embodiments, two of which are described below by way of example:
Sub-embodiment/Method A defines the RB index starting at the RB with lowest frequency within the UL subband as 0. In other words, calculating the resource block index by a first calculation and assuming resource block index is defined as starting at the resource block with lowest frequency within the serving cell frequency resource.
Sub-embodiment/Method B defines the offset value N_{UL,subband} for determination of the first hop. For example, resource block index is determined by RB^{offset}_{BWP}+floor(r_{PUCCH}/N_{CS})+N^{start}_{UL,subband}. In other words, calculating the resource block index by the first calculation and assuming resource block index is defined as starting at the resource block with lowest frequency within the UL subband; or calculating resource block index by a third calculation and assuming resource block index is defined as starting at the resource block with lowest frequency within the serving cell frequency resource

Further, RB^{offset}_{BWP} for the index 15 should be reconsidered since it is determined based on the size of UL BWP (N^{size}_{BWP}). For example, RB^{offset}_{BWP} for the index 15 may be determined by the size of the UL subband (e.g., floor (N^{size}_{UL,subband}/4)).

For example, the resource block index in the second hop for the PUCCH can be determined by N^{size}_{BWP}−1−RB^{offset}_{BWP}−floor(r_{PUCCH}/N_{CS}). For the second hop, Method A or Method B can be applied. Further, the size of UL BWP (N^{size}_{BWP}) may be replaced by the size of the UL subband N^{size}_{UL,subband}.

### G: Further Considerations

It should be understood that the various foregoing example embodiments and modes may be utilized in conjunction with one or more example embodiments and modes described herein.

A PDCCH may be used to transmit downlink control information (DCI). A PDCCH may be transmitted to deliver downlink control information. The terminal device 1 may receive a PDCCH in which downlink control information is arranged. The base station device 3 may transmit the PDCCH in which the downlink control information is arranged.

DCI format is a generic name for DCI format 0_0, DCI format 0_1, DCI format 1_0, and DCI format 1_1. Uplink DCI format is a generic name of the DCI format 0_0 and the DCI format 0_1. Downlink DCI format is a generic name of the DCI format 1_0 and the DCI format 1_1.

The DCI format 0_0 is at least used for scheduling a PUSCH for a cell. The DCI format 0_0 includes at least a part or all of fields 1A to 1E. The 1A is a DCI format identification field (Identifier field for DCI formats). The 1B is a frequency domain resource assignment field (FDRA field). The 1C is a time domain resource assignment field (TDRA field). The 1D is a frequency-hopping flag field. The 1E is an MCS field (Modulation-and-Coding-Scheme field).

The DCI format identification field may indicate whether the DCI format including the DCI format identification field is an uplink DCI format or a downlink DCI format. The DCI format identification field included in the DCI format 0_0 may indicate 0 (or may indicate that the DCI format 0_0 is an uplink DCI format).

The frequency domain resource assignment field included in the DCI format 0_0 may be at least used to indicate the assignment of frequency resources for a PUSCH scheduled by the DCI format 0_0.

The time domain resource assignment field included in the DCI format 0_0 may be at least used to indicate assignment of time resources for a PUSCH scheduled by the DCI format 0_0.

The frequency-hopping flag field may be at least used to indicate whether frequency-hopping is applied to a PUSCH scheduled by the DCI format 0_0.

The MCS field included in the DCI format 0_0 may be at least used to indicate a modulation scheme for a PUSCH scheduled by the DCI format 0_0 and/or a target coding rate for the PUSCH. A size of a transport block (TBS: Transport Block Size) of a PUSCH may be determined based at least on a target coding rate and a modulation scheme for the PUSCH.

The DCI format 0_0 may not include fields used for requesting a CSI report. That is, CSI reporting may not be requested by the DCI format 0_0.

The DCI format 0_0 may not include a carrier indicator field. The terminal device 1 may determine that a serving cell on which a PUSCH scheduled by the DCI format 0_0 is arranged is the same as a serving cell on which a PDCCH including the DCI format 0_0 is arranged.

The DCI format 0_0 may not include a BWP field. The terminal device 1 may determine that the active uplink BWP change for the serving cell on which the PUSCH is arranged doesn't occur by the DCI format 0_0.

The DCI format 0_1 is at least used for scheduling of a PUSCH for a cell. The DCI format 0_1 includes at least a part or all of fields 2A to 2H. The 2A is a DCI format identification field. The 2B is a frequency domain resource assignment field. The 2C is a time domain resource assignment field. The 2D is a frequency-hopping flag field. The 2E is an MCS field. The 2F is a CSI request field. The 2G is a BWP field. The 2H is a carrier indicator field.

The DCI format identification field included in the DCI format 0_1 may indicate 0 (or may indicate that the DCI format 0_1 is an uplink DCI format).

The frequency domain resource assignment field included in the DCI format 0_1 may be at least used to indicate assignment of frequency resources for a PUSCH scheduled by the DCI format.

The time domain resource assignment field included in DCI format 0_1 may be at least used to indicate assignment of time resources for a PUSCH scheduled by the DCI format 0_1.

The frequency-hopping flag field may be at least used to indicate whether frequency-hopping is applied to a PUSCH scheduled by the DCI format 0_1.

The MCS field included in the DCI format 0_1 may be at least used to indicate a modulation scheme for a PUSCH scheduled by the DCI format and/or a target coding rate for the PUSCH.

When the DCI format 0_1 includes the BWP field, the BWP field may be used to indicate an uplink BWP on which a PUSCH scheduled by the DCI format 0_1 is arranged. When the DCI format 0_1 does not include the BWP field, the terminal device 1 may determine that the active uplink BWP change for the serving cell on which the PUSCH is arranged doesn't occur by the DCI format. When the DCI format 0_1 includes the BWP field but the terminal device 1 doesn't have a capability of switching active uplink BWP by indication from DCI formats, the terminal device 1 may determine that the active uplink BWP change for the serving cell on which the PUSCH is arranged doesn't occur by the DCI format.

The CSI request field is at least used to indicate whether CSI reporting is requested or not.

If the DCI format 0_1 includes the carrier indicator field, the carrier indicator field may be used to indicate a serving cell on which a PUSCH is arranged. When the DCI format 0_1 does not include the carrier indicator field, the terminal device 1 may determine that a serving cell on which a PUSCH is arranged may be the same as the serving cell on which a PDCCH including the DCI format 0_1 used for scheduling of the PUSCH is arranged.

The DCI format 1_0 is at least used for scheduling of a PDSCH for a cell. The DCI format 1_0 includes at least a part or all of fields 3A to 3E. The 3A is a DCI format identification field. The 3B is a frequency domain resource assignment field. The 3C is a time domain resource assignment field. The 3D is an MCS field. The 3E is a PDSCH-to-HARQ-feedback indicator field.

The DCI format identification field included in the DCI format 1_0 may indicate 1 (or may indicate that the DCI format 1_0 is a downlink DCI format).

The frequency domain resource assignment field included in the DCI format 1_0 may be at least used to indicate assignment of frequency resources for a PDSCH scheduled by the DCI format 1_0.

The time domain resource assignment field included in the DCI format 1_0 may be at least used to indicate assignment of time resources for a PDSCH scheduled by the DCI format 1_0.

The MCS field included in the DCI format 1_0 may be at least used to indicate a modulation scheme for a PDSCH scheduled by the DCI format 1_0 and/or a target coding rate for the PDSCH. A size of a transport block (TBS: Transport Block Size) of a PDSCH may be given based at least on a target coding rate and a modulation scheme for the PDSCH.

The PDSCH-to-HARQ-feedback timing indicator field may be at least used to indicate the offset (K1) from a slot in which the last OFDM symbol of a PDSCH scheduled by the DCI format 1_0 is included to another slot in which the first OFDM symbol of a PUCCH triggered by the DCI format 1_0 is included.

The DCI format 1_0 may not include the carrier indicator field. The terminal device 1 may determine that a downlink component carrier (or a serving cell) on which a PDSCH scheduled by the DCI format 1_0 is arranged is the same as a downlink component carrier (or a serving cell) on which a PDCCH including the DCI format 1_0 is arranged.

The DCI format 1_0 may not include the BWP field. A downlink BWP on which a PDSCH scheduled by a DCI format 1_0 is arranged may be the same as a downlink BWP on which a PDCCH including the DCI format 1_0 is arranged.

The DCI format 1_1 is at least used for scheduling of a PDSCH for a cell (or arranged on a cell). The DCI format 1_1 includes at least a part or all of fields 4A to 4G. The 4A is a DCI format identification field. The 4B is a frequency domain resource assignment field. The 4C is a time domain resource assignment field. The 4D is an MCS field. The 4E is a PDSCH-to-HARQ-feedback indicator field. The 4F is a BWP field. The 4G is a carrier indicator field.

The DCI format identification field included in the DCI format 1_1 may indicate 1 (or may indicate that the DCI format 1_1 is a downlink DCI format).

The frequency domain resource assignment field included in the DCI format 1_1 may be at least used to indicate assignment of frequency resources for a PDSCH scheduled by the DCI format 1_1.

The time domain resource assignment field included in the DCI format 1_1 may be at least used to indicate assignment of time resources for a PDSCH scheduled by the DCI format 1_1.

The MCS field included in the DCI format 1_1 may be at least used to indicate a modulation scheme for a PDSCH scheduled by the DCI format 1_1 and/or a target coding rate for the PDSCH.

When the DCI format 1_1 includes a PDSCH-to-HARQ-feedback timing indicator field, the PDSCH-to-HARQ-feedback timing indicator field indicates an offset (K1) from a slot including the last OFDM symbol of a PDSCH scheduled by the DCI format 1_1 to another slot including the first OFDM symbol of a PUCCH triggered by the DCI format 1_1. When the DCI format 1_1 does not include the PDSCH-to-HARQ-feedback timing indicator field, an offset from a slot in which the last OFDM symbol of a PDSCH scheduled by the DCI format 1_1 is included to another slot in which the first OFDM symbol of a PUCCH triggered by the DCI format 1_1 is identified by a higher-layer parameter.

When the DCI format 1_1 includes the BWP field, the BWP field may be used to indicate a downlink BWP on which a PDSCH scheduled by the DCI format 1_1 is arranged. When the DCI format 1_1 does not include the BWP field, the terminal device 1 may determine that a downlink BWP on which a PDSCH scheduled by the DCI format 1_1 is arranged is the same as a downlink BWP on which a PDCCH including the DCI format 1_1 is arranged. When the DCI format 1_1 includes the BWP field but the terminal device 1 doesn't have a capability of switching active downlink BWP by indication from DCI formats, the terminal device 1 may determine that an downlink BWP on which a PDSCH scheduled by the DCI format 1_1 is arranged is the same as an downlink BWP on which a PDCCH including the DCI format 1_1 is arranged.

If the DCI format 1_1 includes the carrier indicator field, the carrier indicator field may be used to indicate a downlink component carrier (or a serving cell) on which a PDSCH is arranged. When the DCI format 1_1 does not include the carrier indicator field, the terminal device 1 may determine that a downlink component carrier (or a serving cell) on which a PDSCH is arranged may be the same as a downlink component carrier (or a serving cell) on which a PDCCH including the DCI format 1_1 used for scheduling of the PDSCH is arranged.

A PDSCH may be used to transmit one or more transport blocks. A PDSCH may be used to transmit one or more transport blocks for a DL-SCH. A PDSCH may be used to convey one or more transport blocks. A PDSCH may be used to convey one or more transport blocks for a DL-SCH. One or more transport blocks may be arranged in a PDSCH. One or more transport blocks which corresponds to a DL-SCH may be arranged in a PDSCH. The base station device 3 may transmit a PDSCH. The terminal device 1 may receive the PDSCH.

Downlink reference signals may correspond to a set of resource elements. The downlink reference signals may not carry the information generated in the higher layer. The downlink reference signals may be physical signals used in the downlink component carrier. A downlink physical signal may be transmitted by the base station device 3. The downlink physical signal may be transmitted by the terminal device 1. In the wireless communication system according to one aspect of the present embodiment, at least a part or all of an SS (Synchronization signal), DL DMRS (DownLink DeModulation Reference Signal), CSI-RS (Channel State Information-Reference Signal), and DL PTRS (DownLink Phase Tracking Reference Signal) may be used.

The terminal device may determine, based on the channel bandwidth, at least a part or all of transmission power, output power dynamics, transmit signal quality and spectrum emission mask.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C

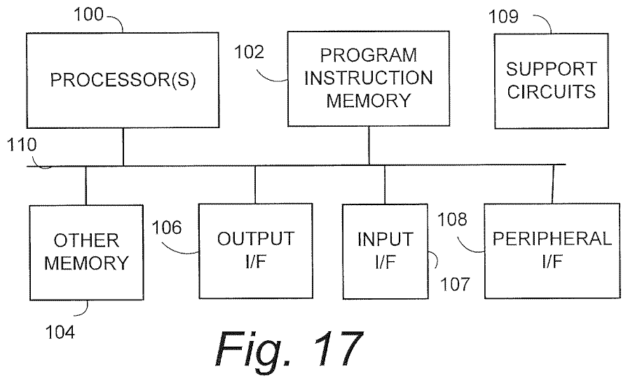

Certain units and functionalities of the systems 20 may be implemented by electronic machinery. For example, electronic machinery may refer to the processor circuitry described herein, such as terminal processor circuitry 60 and base station processor 34. Moreover, the term “processor circuitry” is not limited to mean one processor, but may include plural processors, with the plural processors operating at one or more sites. Moreover, as used herein the term “server” is not confined to one server unit but may encompasses plural servers and/or other electronic equipment and may be co-located at one site or distributed to different sites. With these understandings, FIG. 17 shows an example of electronic machinery, e.g., processor circuitry, as comprising one or more processors 100, program instruction memory 102; other memory 104 (e.g., RAM, cache, etc.); input/output interfaces 106 and 107, peripheral interfaces 108; support circuits 109; and busses 110 for communication between the aforementioned units. The processor(s) 100 may comprise the processor circuitries described herein, for example, terminal processor circuitry 60 and node processor circuitry 34, or any processor(s) of a network entity of the core network.

A memory or register described herein may be depicted by memory 104, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 109 are coupled to the processors 100 for supporting the processor in a conventional manner. These circuits include cache, power supplies, clock circuits, input/output circuitry and subsystems, and the like.

The term “configured” may relate to the capacity of a device whether the device is in an operational or non-operational state. Configured may also refer to specific settings in a device that effect the operational characteristics of the device whether the device is in an operational or nonoperational state. In other words, the hardware, software, firmware, registers, memory values, and/or the like may be “configured” within a device, whether the device is in an operational or nonoperational state, to provide the device with specific characteristics.

An interface may be a hardware interface, a firmware Interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminals and nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves reception and transmission in a telecommunications system, such as by mitigating cross link interference, for example.

One or more of the following documents may be pertinent to the technology disclosed herein (all of which are incorporated herein by reference in their entirety):
RP-213591, New SI: Study on evolution of NR duplex operation
R1-1910603, On wideband operation in NR-U
3GPP TS38.211, v16.8.0, NR; Physical channels and modulation
3GPP TS38.212, v16.8.0, NR; Multiplexing and channel coding
3GPP TS38.213, v16.8.0, NR; Physical layer procedures for control
3GPP TS38.214, v16.8.0, NR; Physical layer procedures for data
3GPP TS38.321, v16.7.0, NR; Medium Access Control (MAC) protocol specification
3GPP TS38.331, v16.7.0, NR; Radio Resource Control (RRC); Protocol specification
3GPP TS38.101-1, v16.11.0, NR; User Equipment (UE) radio transmission and reception

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

### CROSS REFERENCE

This Nonprovisional application claims priority under 35 U.S.C. § 119 on provisional Application No. 63/367,465 on Jun. 30, 2022, the entire contents of which are hereby incorporated by reference.

What is claimed is:

1. A wireless terminal of a cellular telecommunication system, the wireless terminal comprising:
processor circuitry configured to select a PRACH resource from a first PRACH resource associated with SBFD indication and a second PRACH resource not associated with SBFD indication;
transmitter circuitry configured to transmit a PUSCH scheduled by the RAR UL grant which is associated with the PRACH resource;
wherein the resource of the PUSCH is determined based on whether the first PRACH resource or the second PRACH resource is selected.

2. A base station of a cellular telecommunication system, the base station comprising:
processor circuitry configured to select a PRACH resource from a first PRACH resource associated with SBFD indication and a second PRACH resource not associated with SBFD indication;
receiver circuitry configured to receive a PUSCH scheduled by the RAR UL grant which is associated with the PRACH resource;
wherein the resource of the PUSCH is determined based on whether the first PRACH resource or the second PRACH resource is selected.

3. A method of operating a wireless terminal of a cellular telecommunication system, the method comprising:
selecting a PRACH resource from a first PRACH resource associated with SBFD indication and a second PRACH resource not associated with SBFD indication;
transmitting a PUSCH scheduled by the RAR UL grant which is associated with the PRACH resource;
wherein the resource of the PUSCH is determined based on whether the first PRACH resource or the second PRACH resource is selected.
